(19) United States
(12) Patent Application Publication
(10) Pub. No.: US 2012/0050381 A1
(43) Pub. Date: Mar. 1, 2012

(54) INK JET INK COMPOSITION, INK JET RECORDING METHOD, INK CARTRIDGE, RECORDING UNIT, AND INK JET RECORDING APPARATUS

(76) Inventors: Yasuhiro Tanaka, Kanagawa (JP); Ikuko Tsurui, Kanagawa (JP)

(21) Appl. No.: 13/212,339

(22) Filed: Aug. 18, 2011

(30) Foreign Application Priority Data
Aug. 26, 2010 (JP) P2010-189254

(51) Int. Cl. B41J 2/175; C09D 11/02

(52) U.S. Cl. 347/20; 106/31.48; 347/86

(57) ABSTRACT

The ink jet ink composition includes at least a first color material which is an azo compound having a specific structure, a second color material which is an anthrapyridone compound having a specific structure, and a surfactant which is a compound having a specific structure, the surfactant is included in an amount of 0.10% by mass or more and less than 0.80% by mass.

### BACKGROUND

The present disclosure relates to an ink jet ink composition, an ink jet recording method, an ink cartridge, a recording unit, and an ink jet recording apparatus.

An ink jet recording system is a system in which small ink droplets are formed and a part or whole of the ink droplets are attached to recorded materials such as paper and the like to perform recording. This system is expected to be an output method for an image which replaces silver halide photographs with the rapid spread of digital cameras. For this reason, an image obtained by an ink jet recording method is demanded more than ever to have improved fastness which blocks color fading by light or gases such as ozone and the like as well as a high image quality.

Many proposals have been made in the related art for the purpose of improving the fastness. Examples of the color ink frequently used in the ink jet recording method include a cyan ink, a magenta ink, and a yellow ink, and among these, much consideration to improvement of the fastness is particularly given to a magenta ink due to a tendency for low image fastness.

For example, Japanese Unexamined Patent Application Publication No. 2006-143989 proposes an azo colorant having a specific structure as a novel colorant, which has absorption characteristics of excellent color gamut and sufficient fastness as a magenta colorant. Further, Japanese Unexamined Patent Application Publication No. 10-306221 proposes a sulfonic acid derivative of an anthrapyridone compound having a specific structure as a colorant which has a suitable bluish magenta color, has excellent light resistance, and is capable of favorably realizing a color tone in a wide visible region by using it in combination with ink having other colors. In addition, Japanese Unexamined Patent Application Publication No. 2009-191147 proposes an anthrapyridone compound having a specific structure or a salt thereof as a magenta colorant which has high solubility in water, has suitable color and clarity in ink jet recording, and has excellent light resistance, moisture resistance, and gas resistance fastness for recorded matter.

However, it may not be said that these colorants still have an sufficient level of light resistance, as compared with colorants having other colors, such as a yellow colorant and the like.

As a technique to solve these problems, for example, Japanese Unexamined Patent Application Publication No. 2005-105136 and Japanese Unexamined Patent Application Publication No. 2008-297542 propose a magenta ink for forming an image having a good color tone and good light resistance and gas resistance by using an azo colorant having a specific structure in combination with an anthrapyridone compound having a specific structure.

### SUMMARY

Meanwhile, in the ink jet recording method, maintenance which enables recovery from a state in which a head is left to stand for a long period time is performed, but from the viewpoint of increasing a printing speed, it is important to shorten the time necessary for the maintenance. For this reason, the ink used in the ink jet recording method (hereinafter described as the “ink jet ink”) is necessary to have a maintenance saving property for shortening the maintenance time. Particularly, in order to perform high-speed printing, it is important to reduce the frequency of a recovery treatment, called empty discharging, which is one of the maintenance methods.

The empty discharging refers to a recovery treatment in which ink not contributing to the printing of an image from a discharging head to a target recording medium is discharged and the discharging state of the ink becomes favorable. This empty discharging is effective in the case where the discharging rate of the ink is slowed down and the discharging direction varies by increasing the viscosity of the ink near a nozzle for a few seconds to a few tens of seconds when the printing is paused with the nozzle uncapped, but extra time necessary for the empty discharging is further necessary. In contrast, it is thought that even when the printing pause time is long, the empty discharging frequency can be reduced and the printing time can be shortened by using the ink providing a good image quality.

Furthermore, as a recording system of the ink jet recording method, there is a thermal ink jet recording system in which ink is discharged from a recording head by applying thermal energy to perform recording. In this thermal ink jet recording system, it is known that the durability is deteriorated by attachment of carbides on a heating element, called cogation by ink, or on the contrary, occurrence of disconnection caused by the heating elements which are subjected to etching. Therefore, an approach for attaining durability for the heating elements can be mentioned as a performance necessary for an ink jet ink.

Accordingly, although various performances are necessary for the ink jet ink, it is important to control the ink penetration rate into a recording medium in order to obtain an image having a high image quality. As a method for controlling the ink penetration rate, it has been known, for example, to add materials called a penetration aid or a surfactant. In particular, an acetylene glycol-based surfactant as a surfactant used in the ink jet ink has an excellent performance of controlling a penetration rate as well as excellent characteristics such as few side-effects on the durability for a heating element, and the like.

However, it was demonstrated by investigation of the present inventors that in the case where the acetylene glycol-based surfactant having excellent characteristics is used in combination with a specific dye, the surfactant does not sufficiently exert its surface-active performance. This problem occurs, specifically in the case where an ethylene oxide adduct of acetylene glycol is used as a surfactant in the ink composition containing an azo dye having a specific structure described in Japanese Unexamined Patent Application Publication No. 2006-143989, Japanese Unexamined Patent Application Publication No. 2005-105136, and Japanese Unexamined Patent Application Publication No. 2008-297542 above. The mechanism with which the problem occurs is unclear, but it can be seen that since the surface-active performance is not sufficiently exerted, the penetration rate of the ink into a recording medium is low and the color bleeding property is deteriorated, and as a result, a high-quality image is not obtained.

Here, in order to sufficiently secure the permeability of the ink into the target recording medium, a method in which a larger amount of a surfactant is added, as compared with the cases of using other dyes, is considered. However, it was proved that if the amount of the additives such as a surfactant and the like is increased, the printing pause time acceptable for obtaining good printing is remarkably shortened and the intermittent discharging stability is deteriorated. In addition, it could be seen that there occurs a problem that an increased amount of the additives causes decreased durability for the heating element due to cogation or etching.

Therefore, the present disclosure has been made in consideration of the above-described problems, and it is desirable to provide an ink jet ink composition, which is capable of printing an image having excellent fastness with a high image quality and has excellent intermittent discharging stability. Further, it is also desirable to provide an ink jet recording method, an ink cartridge, a recording unit, and an ink jet recording apparatus, in each of which an image having excellent fastness with a high image quality is obtained by using the ink jet ink composition.

In order to solve the above-described problems, according to an embodiment of the present disclosure, there is provided an ink jet ink composition, including at least a first color material which is an azo compound represented by the following general formula (I), a second color material which is an anthrapyridone compound represented by the following general formula (II), and a surfactant which is a compound having a structure represented by the following general formula (III), in which the surfactant is contained in an amount of 0.10% by mass or more and less than 0.80% by mass.

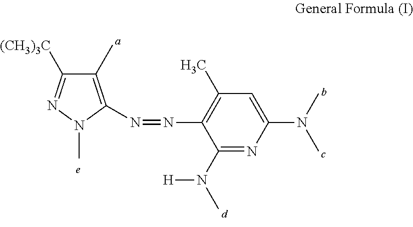

In the general formula (I), a is an electron withdrawing group having a Hammett's σp value of 0.20 or more and less than 1.00. Further, b and d are each independently a phenyl group having one sulfo group, and a hydrogen atom of the phenyl group may be further substituted. In addition, c and e each independently include a benzothiazole ring group having one sulfo group, and a hydrogen atom of the benzothiazole ring group may be further substituted.

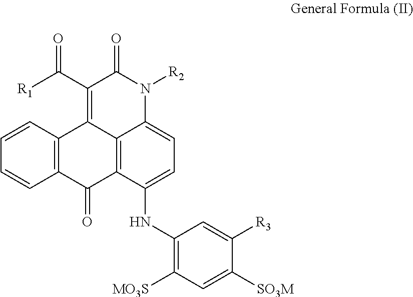

In the general formula (II), R₁ is an alkoxy group having 1 to 6 carbon atoms or a 3-sulfophenyl group, and R₂ is a hydrogen atom or a methyl group. R₃ is a hydrogen atom or a methyl group, and a hydrogen atom of the methyl group may be further substituted, for which, however, a substituent bridged with an imino bridge (—NH—) may not be chosen. Further, each M is independently a hydrogen atom, an alkali metal, ammonium, or organic ammonium.

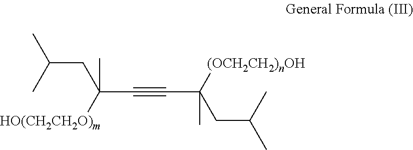

In the general formula (III), m and n are an integer of 1 or more.

In the ink jet ink composition, the first color material may also be a compound represented by the following general formula (IV).

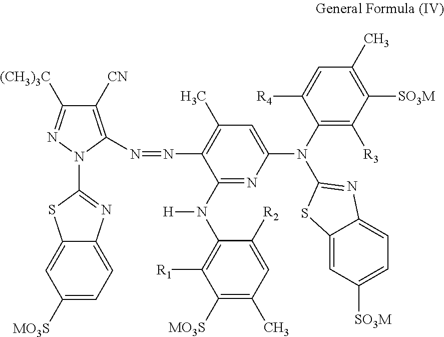

In the general formula (IV), R₁, R₂, R₃, and R₄ are each independently an alkyl group, and a hydrogen atom of the alkyl group may be further substituted. Further, each M is independently a hydrogen atom, an alkali metal, ammonium, or organic ammonium.

In the ink jet ink composition, the second color material may also be a compound represented by the following general formula (V).

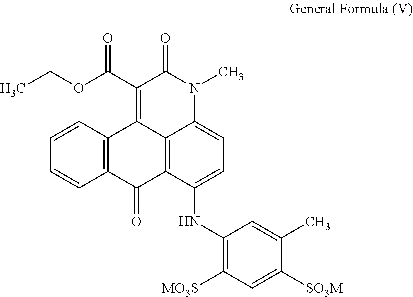

In the general formula (V), each M is independently a hydrogen atom, an alkali metal, ammonium, or organic ammonium.

In the ink jet ink composition, the total content of the first color material and the second color material in the ink composition is preferably 1.00% by mass or more and 5.00% by mass.

In the ink jet ink composition, the content (% by mass) of the first color material in the ink composition is preferably 0.50 times or more and 4.00 times or less the content (% by mass) of the second color material in the ink composition in terms of a mass ratio.

In the ink jet ink composition, the surfactant preferably has an HLB (Hydrophile-Lipophile Balance) value of 10 or more.

Moreover, in order to solve the above-described problems, according to another embodiment of the present disclosure, there is provided an ink jet recording method, including discharging liquid droplets of an ink jet ink composition by an ink jet system to perform recording, wherein the ink composition includes at least a first color material which is an azo compound represented by the general formula (I), a second color material which is an anthrapyridone compound represented by the general formula (II), and a surfactant which is a compound having a structure represented by the general formula (III), in which the surfactant is contained in an amount of 0.10% by mass or more and less than 0.80% by mass.

Furthermore, in order to solve the above-described problems, according to still another embodiment of the present disclosure, there is provided an ink cartridge including an ink-storing unit for storing an ink jet ink composition including at least a first color material which is an azo compound represented by the general formula (I), a second color material which is an anthrapyridone compound represented by the general formula (II), and a surfactant which is a compound having a structure represented by the general formula (III), in which the surfactant is contained in an amount of 0.10% by mass or more and less than 0.80% by mass.

Furthermore, in order to solve the above-described problems, according to still another embodiment of the present disclosure, there is provided a recording unit including an ink cartridge having an ink-storing unit for storing an ink jet ink composition including at least a first color material which is an azo compound represented by the general formula (I), a second color material which is an anthrapyridone compound represented by the general formula (II), and a surfactant which is a compound having a structure represented by the general formula (III), in which the surfactant is contained in an amount of 0.10% by mass or more and less than 0.80% by mass, and a recording head for discharging liquid droplets of the ink composition stored in the ink-storing unit.

Furthermore, in order to solve the above-described problems according to still another embodiment of the present disclosure, there is provided an ink jet recording apparatus including an ink cartridge having an ink-storing unit for storing an ink jet ink composition including at least a first color material which is an azo compound represented by the following general formula (I), a second color material which is an anthrapyridone compound represented by the following general formula (II), and a surfactant which is a compound having a structure represented by the following general formula (III), in which the surfactant is contained in an amount of 0.10% by mass or more and less than 0.80% by mass, and a recording head for discharging liquid droplets of the ink composition stored in the ink-storing unit.

According to the embodiment the present disclosure, an ink jet ink composition, which is capable of printing an image having excellent fastness with a high image quality and has an excellent intermittent discharging property and a preferable color tone as a magenta ink, can be provided. Further, according to the embodiments of the present disclosure, an ink jet recording method, an ink cartridge, a recording unit, and an ink jet recording apparatus, in each of which an image having excellent fastness with a high image quality is obtained by using the ink jet ink composition, can be provided.

### BRIEF DESCRIPTION OF THE DRAWINGS

FIG. 1 is an exploded perspective view showing an example of the entire constitution of an ink jet recording apparatus according to a suitable embodiment of the present disclosure.

FIG. 2 is an exploded perspective view showing the constitution of a head cartridge provided in the ink jet recording apparatus 100 of FIG. 1.

FIG. 3 is a cross-sectional view obtained by cutting the head cartridge shown in FIG. 2 along the line.

FIGS. 4A and 4B are cross-sectional views showing the constitution of the recording head provided in the head cartridge shown in FIG. 3, in which 4A schematically shows the state of bubbles generated on a heating element and 4B schematically shows the state of ink droplets discharged from a nozzle.

### DETAILED DESCRIPTION OF EMBODIMENTS

With reference to the accompanying drawings below, suitable embodiments of the present disclosure will be described in detail. Further, in the specification and drawings, the same constituting elements having substantially the same function constitutions are attached with the same symbols to omit duplicate explanation.

Furthermore, description will be made in the following order:

1. Problems of Related Art and Investigation on Means for Solving the Same

2. Ink Jet Ink Composition According to Suitable Embodiment of the Disclosure

3. Ink Jet Recording Method According to Suitable Embodiment of the Disclosure

4. Ink Cartridge According to Suitable'Embodiment of the Disclosure

5. Recording Unit According to Suitable Embodiment of the Disclosure

6. Ink Jet Recording Apparatus According to Suitable Embodiment of the Disclosure

7. Conclusion

### 1. PROBLEMS OF RELATED ART AND INVESTIGATION ON MEANS FOR SOLVING THE SAME

First, before describing the ink jet ink composition and the like according to a suitable embodiment of the present disclosure, the problems of the related art discovered by the present inventors and novel knowledge obtained by investigation of the present inventors will be described.

### 1.1. Problems of Related Art

As described above, in recent years, there is a demand for an increasing level of fastness of a dye (color material) used in the ink employed for an ink jet recording method. Thus, the present inventors have investigated an ink composition containing an azo dye having a structure of the following general formula (I) from the azo dye having excellent fastness described in Japanese Unexamined Patent Application Publication No. 2006-143989, Japanese Unexamined Patent Application Publication No. 2005-105136, and Japanese Unexamined Patent Application Publication No. 2008-297542.

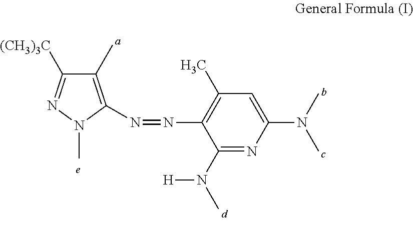

Here, an acetylene glycol-based surfactant has an excellent ability of controlling the penetration rate of ink as well as few side-effects on durability on a heating element, as described above. However, it was confirmed that when an ethylene oxide adduct of acetylene glycol which is one of acetylene glycol-based surfactants (refer to the following general formula (III)) was chosen as a surfactant which is added to an ink composition containing the azo dye, the surface-active performance is not sufficiently exerted. The mechanism of this phenomenon is unclear, but it could be seen that the surface-active performance is not sufficiently exerted, and accordingly, the penetration rate of the ink composition into a recording medium is low and the color bleeding property is deteriorated, leading to occurrence of a problem that a high-quality image is not obtained.

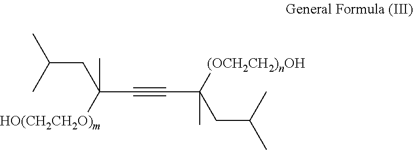

With respect to the problems, in order to sufficiently secure the permeability of the ink composition into a recording medium, an approach in which more surfactants are added, as compared with a case of using other dyes, is considered. However, it could be seen that if the content of the additives such as a surfactant and the like in the ink composition is increased, there occurs a problem that a printing pause time acceptable for obtaining a good image is remarkably shortened, and thus, the intermittent discharging stability is deteriorated. In addition, it could be seen that an increased amount of the additives such as a surfactant and the like causes the durability for a heating element to be lowered due to cogation or etching.

Furthermore, Japanese Unexamined Patent Application Publication No. 2009-256600 points out a problem on sticking resistance or intermittent discharging stability in ink in which a dye having the structure of the general formula (I) is used. To solve the problem, Japanese Unexamined Patent Application Publication No. 2009-256600 proposes to use bis(2-hydroxyethyl)sulfone. However, according to Examples thereof, a larger amount (0.8% by mass, or more) of an acetylene glycol-based surfactant than that usually preferably used is added. Thus, in Japanese Unexamined Patent Application Publication No. 2009-256600, the level at which the intermittent discharging stability is considered good, specifically, the non-discharging time for obtaining good discharging (printing pause time) is merely around 3 seconds or more. At this level of the non-discharging time, the intermittent discharging stability is not sufficient for high-speed printing.

In addition, it is clear that even when the amount of the acetylene glycol-based surfactant to be added is 0.1% by mass or more and 0.8% by mass or less, which is a usually preferably used amount, in order to obtain sufficient permeability into a recording medium, good intermittent discharging stability is obtained even for a long period of time such as a printing pause time of well over 10 seconds.

### 1.2. Investigation on Means for Solving the Problems

Therefore, the present inventors have extensively conducted studies in order to obtain an ink jet ink composition, which is capable of printing an image having excellent fastness with a high image quality and has excellent intermittent discharging stability as well as a preferable color tone as a magenta ink as well as excellent durability for a heating element. Hereinbelow, the results of the investigation will be described in detail.

(1.2.1. Investigation on Intermittent Discharging Stability)

First, the present inventors have investigated an ink jet ink composition, in which an azo compound (dye) of the general formula (I) is used as a color material in order to obtain an ink composition having good color as magenta and excellent fastness against light and active gases (particularly an ozone gas) in the environment. As a result, a phenomenon that if the azo dye is used in combination with an acetylene glycol-based surfactant represented by the general formula (III), the surface-active performance of the acetylene glycol-based surfactant is not sufficiently exerted, although the mechanism is unclear, was confirmed. That is, if the azo compound of the general formula (I) is used as a color material, the surface tension of the ink composition is not sufficiently lowered even with the same content of the acetylene glycol-based surfactant, as compared with the cases where other dyes are used. From this, it could be seen that if the dye represented by the general formula (I) is used in combination, the ink penetration rate is lowered, the color bleeding property becomes poor, and a high-quality image is not obtained, although the same amount of the acetylene glycol-based surfactant is used as in the cases where other dyes are used.

With respect to these problems, it could be seen that when the amount of the surfactant to be added is set to 0.80% by mass or more based on the total amount of the ink composition in order to sufficiently secure the penetration rate of the ink into the recording medium, the penetration rate is high and a high-quality image without generation of bleed or the like is obtained. However, it was proved that if the amount of the additives such as a surfactant and the like is increased, the intermittent discharging stability is deteriorated, that is, a printing pause time acceptable for obtaining a good image is remarkably shortened.

Therefore, the present inventors have investigated improving the intermittent discharging stability of the ink composition without increasing the amount of the surfactant to be added. As a result, they have solved the above-described problems by adding the anthrapyridone compound (dye) represented by the following general formula (II) to an ink composition containing the azo compound of the general formula (I) and the acetylene glycol-based surfactant of the general formula (III). That is, the present inventors have found that by the combined use of the compound represented by the general formula (I) and the compound represented by the general formula (II), a smaller amount of an acetylene glycol-based surfactant can lower the surface tension, as compared with a case where the compound of the general formula (I) is used alone. This effect is not fully discussed in Japanese Unexamined Patent Application Publication No. 2009-256600 above, but the present inventors have found that the effect is a phenomenon occurring specifically in the case of the combined use of the compound represented by the general formula (I) and the compound represented by the general formula (II). The inventors have assumed that the structure having a substituent bridged with an imino bridge (—NH—) at an R₃ position of the compound of the general formula (II) gives an effect on the surface-active performance of the acetylene glycol-based surfactant. In addition, it is thought that since such a structure does not exist in the compound of the general formula (II) described in Japanese Unexamined Patent Application Publication No. 2009-256600, the surface-active performance of the acetylene glycol-based surfactant is lowered.

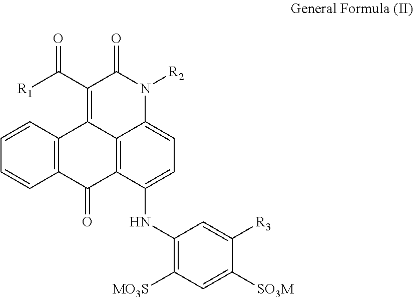

As described above, the present inventors have contemplated an ink composition containing the azo compound represented by the general formula (I), the anthrapyridone compound represented by the general formula (II), and the acetylene glycol-based surfactant represented by the general formula (III). In the ink composition according to an embodiment of the present disclosure, the acetylene glycol-based surfactant is added in approximately the same amount as the amount usually employed in the cases where other dyes are used, that is, in an amount in the range of 0.10% by mass or more and less than 0.80% by mass, based on the total amount of the ink composition. Accordingly, in the ink composition according to an embodiment of the present disclosure, an excess amount of the additive does not cause a problem that the intermittent discharging stability is deteriorated. Further, the ink composition according to an embodiment of the present disclosure has a good color as a magenta and excellent fastness against light and active gases (particularly an ozone gas) in the environment. Therefore, by using the ink composition according to an embodiment of the present disclosure in an ink jet recording method, the ink droplets can be discharged well even with a long printing pause time, a load on maintenance can be reduced and an image have excellent fastness with a high image quality can be stably obtained.

(1.2.2. Investigation on Fastness of Color Material and the Like)

Moreover, as a result of investigation by the present inventors, it was proved that in the case of adding the compound of the general formula (II) in order to provide high intermittent discharging stability, there is also an effect of improvement of light resistance as in the ink described in Japanese Unexamined Patent Application Publication No. 2008-297542. That is, also in the combination of the compound of the general formula (I) and the compound of the general formula (II) in the present disclosure, remarkably superior light resistance can be realized by combination of those color materials at specific mass ratios, as compared with the light resistance of the ink composition expected from the light resistance which the color materials individually have.

The mechanism of improving the light resistance is not clear, but the present inventors assumed the reason therefor is as follows. It could be seen that the same azo-based dye as the compound of the general formula (I) in the present disclosure tends to have a high fixing property on an ink-receiving layer of a recording medium. It is thought that since application of an ink composition containing an azo-based dye onto a recording medium leads to characteristics that the fixing property is high, the adsorption amount on a porous body is high, and as a result, the dye does not penetrate to a shallow position in the thickness direction of the ink-receiving layer. On the other hand, as a result of investigation by the present inventors, it could be seen that an anthrapyridone-based dye like the compound of the general formula (II) has a low fixing property on the ink-receiving layer of the recording medium. It is thought that since application of an ink composition containing an anthrapyridone-based dye onto a recording medium leads to characteristics that the fixing property is low, the adsorption amount on a porous body is low, and as a result, the dye penetrates into a deep position in the thickness direction of the ink-receiving layer.

If the ink composition of the present disclosure containing the compound of the general formula (I) which is an azo-based dye and the compound of the general formula (II) which is an anthrapyridone-based dye, each having the above-described characteristics, is applied onto a recording medium, it reaches a state as follows. It is thought that the compound of the general formula (I) does not penetrate to a shallow position in the thickness direction of the ink-receiving layer, whereas the compound of the general formula (II) penetrates to a deep position in the thickness direction of the ink-receiving layer. That is, the compound of the general formula (I) and the compound of the general formula (II) are different in the positions of the ink-receiving layer distributed in the thickness direction. For this reason, it is thought that the compound of the general formula (I) distributed in a shallow position in the thickness direction of the ink-receiving layer plays a role in inhibiting the compound of the general formula (II) photolyzed in a deep position in the thickness direction of the ink-receiving layer from being decomposed. As a result, it is inferred that remarkably superior light resistance can be realized by combination of those color materials at specific mass ratios, as compared with the light resistance of the ink composition expected from the light resistance which the compound of the general formula (I) and the compound of the general formula (II) individually have.

(1.2.3. Investigation on Color Tone)

Further, as a result of investigation by the present inventors, the following could be seen. The first color material represented by the general formula (I) has a yellowish magenta color tone and has characteristics that the optical density of recorded matter is high. On the other hand, the second color material represented by the general formula (II) has a bluish magenta color tone and has characteristics that the optical density of recorded matter is low. In the present disclosure, since the first color material represented by the general formula (I) and the second color material represented by the general formula (II), each having the same characteristics as above, are used in combination, an image having a preferable magenta color tone is obtained. In addition, by setting the mixing ratios of the first color material and the second color material to specific ranges, it becomes possible to prepare an ink composition which has excellent fastness of an image and intermittent discharging stability of ink, is capable of providing a high-quality image, and has a preferable color tone as a magenta ink.

Here, specifically, the preferable magenta color tone as mentioned in the present disclosure refers to the following. That is, an image formed using a magenta ink by setting a recording duty as 100% is measured for the values of a* and b* in the L*a*b* color coordinate system defined by the CIE (International Commission on Illumination). Further, the hue angle (H°) calculated according to the following formula (A) from the resulting values of a* and b* is investigated regarding whether it is 0° or more and 5° or less or whether it is 350° or more and less than 360°. As a result, in the present disclosure, an ink composition satisfying the above-described conditions is defined as an ink composition having a preferable color tone as a magenta ink. Further, the hue angle (H°) calculated in accordance with the following formula (A) is particularly preferably 0° or more and 5° or less. Further, the values of a* and b* can be measured using, for example, a spectrophotometer (trade name: Spectrolino; manufactured by Gretag Macbeth), but the present disclosure is not limited to the method above.

In a*≧0, b*≧0 (the first quadrant): H°=tan⁻¹ (b*/a*)

In a*≦0, b*≧0 (the second quadrant): H°=180+tan⁻¹ (b*/a*)

In a≦0, b*≦0 (the third quadrant): H°=180+tan⁻¹ (b*/a*)

In a*≧0, b*≦0 (the fourth quadrant): H°=360+tan⁻¹ (b*/a*) Formula (A)

### 2. INK JET INK COMPOSITION ACCORDING TO SUITABLE EMBODIMENT OF THE DISCLOSURE

As a result of the investigation as described above, it was found that it is suitable to use an azo compound (dye) having the structure of the general formula (I) as a color material in order to provide high fastness. Further, it was also found that it is suitable to add an acetylene glycol-based surfactant to an ink composition in which the dye is used in order to control the penetration rate of the ink. Further, the present inventors have found that by further adding an anthrapyridone compound (dye) having the structure of the general formula (II) to an ink composition containing the dye and the surfactant, an ink composition which has excellent intermittent discharging stability of the ink and a preferable color tone as magenta while not interfering with sufficient permeability into a recording medium, in addition to excellent light resistance and ozone resistance (fastness).

The present disclosure has been made on the basis of the related findings and its main characteristics consists in the combined use of a specific azo-based dye, a specific anthrapyridone-based dye, and an acetylene glycol-based surfactant. Hereinbelow, the components constituting the ink jet ink composition according to a suitable embodiment of the present disclosure (hereinafter simply also referred to as the “ink composition”) and the physical properties or the like of the ink composition will be described in detail.

### 2.1. First Color Material

First, the azo compound represented by the general formula (I) which is used as a first color material in the ink composition according to the present embodiment is described. It is necessary that the ink composition according to the present embodiment contain an azo compound represented by the following general formula (I) as a first color material for the purpose of improving the fastness of an image.

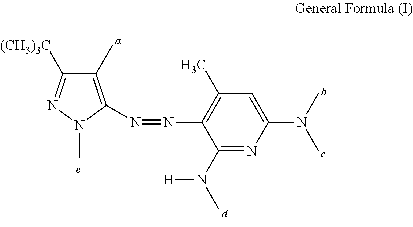

In the general formula (I), from the viewpoint of improvement of fastness, or the like, a is an electron withdrawing group having a Hammett's substituent constant σp value (hereinafter referred to as a “Hammett's σp value”) of 0.20 or more and less than 1.00, and the Hammett's σp value is preferably 0.60 or more and less than 1.00.

Here, the Hammett rule and the Hammett's substituent σp value will be described. The Hammett rule is an empirical rule proposed by L. P. Hammett in 1935 to quantitatively discuss an influence of a substituent exerted on a reaction and equilibrium of a benzene derivative, and nowadays, its validity has been widely recognized. The substituent constants found by the Hammett rule include a σp value and a am value, and these values are described in many general documents. There are specific descriptions in, for example, “Lange's Handbook of Chemistry” edited by J. A. Dean, 12^{th} Ed., 1979 (McGraw-Hill), and “Region of Chemistry”, extra number, No. 122, pp. 96-103, 1979 (Nankodo Co., Ltd.), Chemical Handbook (Rev. 5^{th} Ed.) of Maruzen Co., Ltd., or the like. Further, in the present embodiment, each substituent is described as defined by the Hammett's substituent constant σp, but this does not mean that the substituent in the present embodiment is limited to the substituents having the existing values in the above-mentioned documents. However, even when the values of the substituent constants are not described in the above-mentioned documents, if when the values are calculated based on the Hammett rule, they are considered to fall within the range, and are also encompassed.

Examples of the electron withdrawing group having a Hammett's σp value of 0.60 or more include a cyano group (—CN), a nitro group (—NO₂), an alkylsulfonyl group (RSO₂—), and the like. In the present embodiment, it is particularly preferable to choose a cyano group as a in the general formula (I). Further, examples of the electron withdrawing group having a Hammett's σp value of 0.20 or more and less than 0.60 include a chloro group (—Cl), an ethyl ester group (CO₂Et), a carboxyl group (—COOH), an acetyl group (—COCH₃), and the like.

In the general formula (I), b and d are each independently a phenyl group having one sulfo group represented by the following general formula (a), and a hydrogen atom of the phenyl group may be further substituted.

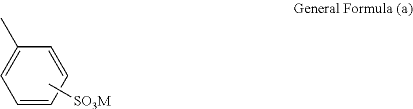

each M is independently a hydrogen atom, an alkali metal, ammonium, or organic ammonium (for example, ammonium in which a hydrogen atom is substituted with an organic group such as an alkyl group, an aryl group, and the like, including primary to quaternary ammonium, and the like. This shall apply to the description below).

Furthermore, in the general formula (I), c and e each independently include a benzothiazole ring group having one sulfo group represented by the following general formula (b), and a hydrogen atom of the benzothiazole ring group may be further substituted.

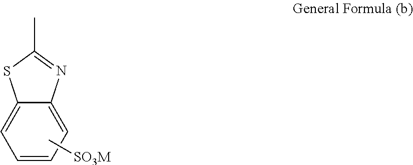

each M is independently a hydrogen atom, an alkali metal, ammonium, or organic ammonium.

As the first color material in the present embodiment, in particular, a compound represented by the following general formula (IV) is preferably used, among the compounds represented by the general formula (I).

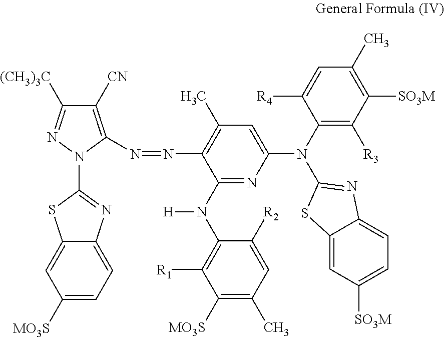

In the general formula (IV), R₁, R₂, R₃, and R₄ are each independently an alkyl group, and a hydrogen atom of the alkyl group may be further substituted. If a large alkyl group is substituted at the positions of R₁, R₂, R₃, and R₄, the steric hindrance increases and the yield of the compound of the general formula (IV) or the stability is lowered. Thus, as the alkyl group chosen as R₁, R₂, R₃, and R₄, a methyl group and an ethyl group, each having a short alkyl chain, are particularly preferred. Further, each M is independently a hydrogen atom, an alkali metal, ammonium, or organic ammonium.

Furthermore, preferable specific examples of the compound represented by the general formula (I) include the following Exemplary Compounds 1 to 4. Of course, the first color material in the present embodiment is not limited to the following Exemplary Compounds 1 to 4 as long as it is the compound included by the general formula (I). However, it is particularly preferable to use the Exemplary Compound 1, among the following Exemplary Compounds, as the first color material in the present embodiment, from the viewpoint that it has excellent image fastness and an excellent color developing property, and has excellent basic characteristics as a magenta dye, such as high solubility in water and the like.

Exemplary compound 1

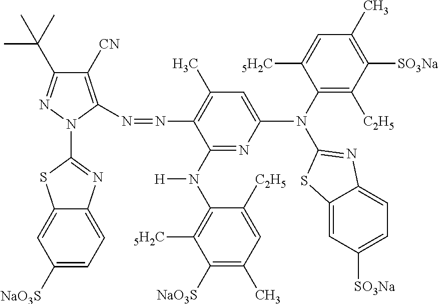

Exemplary compound 2

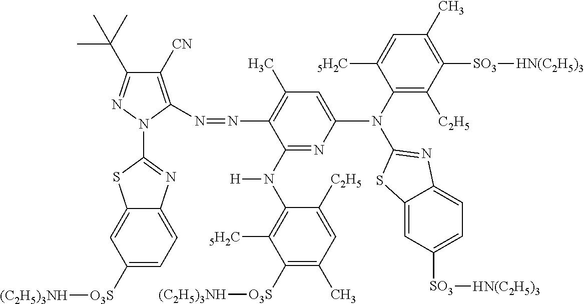

Exemplary compound 3

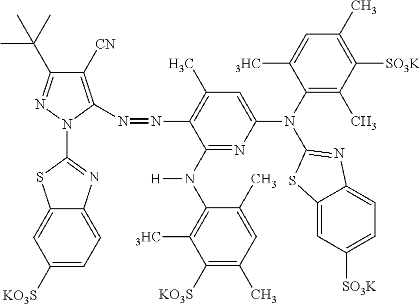

Exemplary compound 4

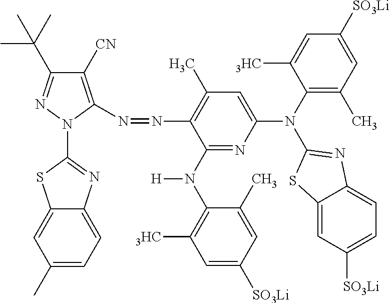

### 2.2. Second Color Material

Next, the anthrapyridone compound represented by the general formula (II) as a second color material in the ink composition according to the present embodiment will be described. As described above, if the compound of the general formula (I) and the acetylene glycol-based surfactant represented by the general formula (III), each having excellent fastness of an image, are used in combination, there is a problem that a function to lower the surface tension of the surfactant is not sufficiently exerted. Therefore, for the purpose of solving the problems, it is necessary for the ink composition according to the present embodiment to contain the following the anthrapyridone compound represented by the general formula (II) as a second color material.

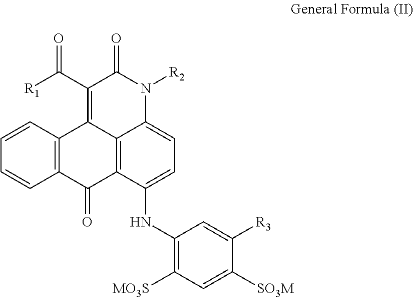

In the general formula (II), R₁ is an alkoxy group having 1 to 6 carbon atoms or a 3-sulfophenyl group, and R₂ is a hydrogen atom or a methyl group. R₃ is a hydrogen atom or a methyl group, and a hydrogen atom of the methyl group may be further substituted, for which a substituent bridged with an imino bridge (—NH—) is not chosen. Further, each M is independently a hydrogen atom, an alkali metal, ammonium, or organic ammonium.

Here, the present inventors have assumed that the reason why a function of the surfactant is not exerted is that the structure of the compound of the general formula (I) used as a color material having excellent fastness inhibits the surface-active performance of the surfactant of the general formula (III), but the mechanism is not clearly figured out. However, as a result of investigation by the present inventors, it was proved that the addition of the compound represented by the general formula (II) as a second color material to the ink composition can sufficiently lower the surface tension while not increasing the amount of the surfactant to be added. In addition, the compound, in which a substituent bridged with an imino bridge (—NH—) is chosen as R₃ in the general formula (II), is a color material having excellent fastness. However, as confirmed by the present inventors, with the compound having such a structure, an effect of sufficiently lowering the surface tension while not increasing the amount of the surfactant to be added was not observed.

Furthermore, it is particularly preferable to use the compound of the general formula (V), among the compounds represented by the general formula (II), as a second color material in the present embodiment.

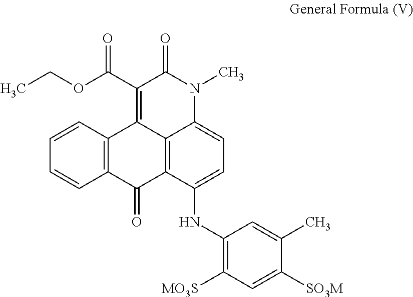

In the general formula (V), each M is independently a hydrogen atom, an alkali metal, ammonium, or organic ammonium.

Preferable specific examples of the compound represented by the general formula (II) include the following Exemplary Compounds 5 to 8. Of course, the second color material in the present embodiment is not limited to the following Exemplary Compounds 5 to 8 as long as it is a compound encompassed by the general formula (II). However, it is particularly preferable to use the Exemplary Compound 5, among the following Exemplary Compounds, as the first color material in the present embodiment, from the viewpoint that it can solve the problems concerning the findings of the function of the surfactant as described above and it has excellent image fastness or color developing property.

Exemplary compound 5

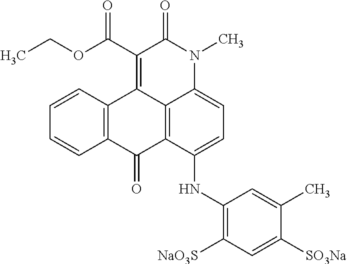

Exemplary compound 6

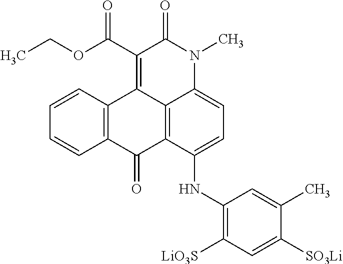

Exemplary compound 7

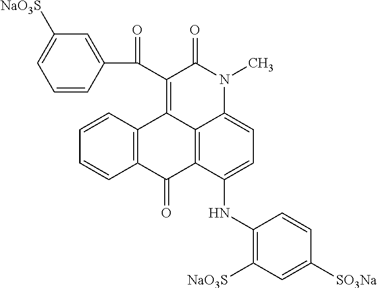

Exemplary compound 8

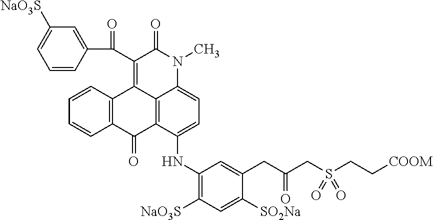

### 2.3. Surfactant

Next, the ethylene oxide adduct of acetylene glycol represented by the general formula (III) which is used as a surfactant in the ink composition according to the present embodiment will be described. It is necessary for the ink composition according to the present embodiment to contain an ethylene oxide adduct of acetylene glycol as a surfactant represented by the following general formula (III) for the purpose of controlling the penetration rate of the ink composition into a recording medium, improving the color bleeding property, and obtaining a high-quality image.

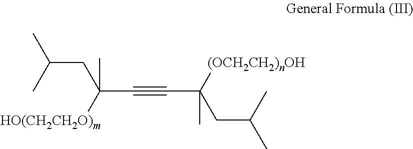

In the general formula (III), m and n are an integer of 1 or more.

Here, it is important that the ink composition according to the present embodiment contain the ethylene oxide adduct of acetylene glycol represented by the general formula (III) (acetylene glycol-based surfactant) in an amount of 0.10% by mass or more and less than 0.80% by mass, based on the total amount of the ink composition. Thus, by setting the content of the acetylene glycol-based surfactant to 0.10% by weight or more, sufficient permeability into a recording medium can be obtained. Further, by setting the content of the acetylene glycol-based surfactant to less than 0.80% by mass, generation of blur (bleed) of an image is prevented, and further, the intermittent discharging stability is excellent, a printing pause time acceptable for obtaining a good image can be increased, and a maintenance load can be reduced. From the viewpoint of improving the effect, the content of the acetylene glycol-based surfactant of the general formula (IV) is preferably about 0.5% by mass.

As the ethylene oxide adduct of acetylene glycol represented by the general formula (III), commercially available products such as Surfynol 465, Surfynol 485, Olfine E1010 manufactured by Nissin Chemical Industry Co., Ltd., Acetylenol E100 manufactured by Kawaken Fine Chemicals Co., Ltd., and the like can be used. Of course, the surfactant in the present embodiment is not limited to the products as long as it is a compound encompassed by the general formula (III).

Moreover, in the present embodiment, from the viewpoint of further improving the color bleeding property and obtaining a higher-quality image, the HLB (Hydrophile-Lipophile Balance) value of the surfactant represented by the general formula (III) is particularly preferably 10 or more.

### 2.4. Content of Color Material

With the ink composition according to the present embodiment, the total content of the first color material represented by the general formula (I) and the second color material represented by the general formula (II) (hereinafter sometimes described as the “total amount of the color materials”) is preferably 1.00% by mass or more and 5.00% by mass or less, based on the total mass of the ink composition.

If the total amount of the color materials is less than 1.00% by mass, the density of the printed matter is not sufficiently obtained in some cases. Further, if the total amount of the color materials is more than 5.00% by mass, the intermittent discharging stability of the ink composition drops in some cases. In addition, it could be seen that by setting the total amount of the color materials to the above-described range, even when the ink jet ink composition according to the present embodiment, having a content (% by mass) of the acetylene glycol-based surfactant represented by the general formula (III) of 0.10% by mass or more and less than 0.80% by mass, is applied to a thermal ink jet recording system, in which ink is discharged by applying thermal energy, the ink is provided with excellent durability for the heater (heating element) of the recording head.

### 2.5. Content Ratio of Color Material

Furthermore, with the ink composition according to the present embodiment, the mass ratio of the content (% by mass) of the first color material represented by the general formula (I) to the content (% by mass) of the second color material represented by the general formula (II) is preferably 0.50 times or more and 4.00 times or less, based on the total mass of the ink composition.

By setting the content ratio of the first color material to the second color material to the above-described range, the surface-active performance of the acetylene glycol-based surfactant represented by the general formula (III) can be sufficiently maintained, and further, an ink composition which is capable of realizing excellent light resistance and giving an image of a color tone particularly preferable as a magenta ink can be provided.

### 2.6. Method for Characterization of Color Material

The compounds (color materials) of the general formulae (I) and (II) can be identified by, for example, High Performance Liquid Chromatography (HPLC), Fourier Transform Infrared Spectral Photometer (FT-IR), and Nuclear Magnetic Resonance (NMR) methods, or mass spectrometry such as Fast Atom Bombardment Mass Spectrometer (FABMS), Pyrolysis Gas Chromatography Mass Spectrometry (PyGC/MS), Liquid Chromatography Mass Spectrometry (LC/MS), and the like.

### 2.7. Solvent

In the ink composition according to the present embodiment, water or a mixed solvent of water and a water-soluble organic solvent can be used as a solvent (aqueous medium).

As water, deionized water (ion exchange water) is preferably used. The content (% by mass) of water in the ink composition is preferably 60.0% by mass or more and 90.0% by mass or less, and more preferably 70.0% by mass or more and 90.0% by mass or less, based on the total mass of the ink composition.

The water-soluble organic solvent is not particularly limited as long as it is water-soluble, and as such a solvent, an alcohol, a polyhydric alcohol, a polyglycol, a glycol ether, and other polar solvents can be used. Specific examples of the water-soluble organic solvent include alkyl alcohols each having 1 to 4 carbon atoms, such as methyl alcohol, ethyl alcohol, n-propyl alcohol, isopropyl alcohol, n-butyl alcohol, sec-butyl alcohol, tert-butyl alcohol, and the like; amides such as dimethylformamide, dimethylacetamide, and the like; ketones or keto alcohols such as acetone, diacetone alcohol, and the like; ethers such as tetrahydrofuran, dioxane, and the like; polyalkylene glycols such as polyethylene glycol, polypropylene glycol, and the like; glycols such as ethylene glycol, propylene glycol, butylene glycol, diethylene glycol, triethylene glycol, hexylene glycol, thiodiglycol, and the like; alkylene glycols in which alkylene groups have 2 to 6 carbon atoms, such as 1,5-pentanediol, 1,6-hexanediol, 2-methyl-1,3-propanediol, 3-methyl-1,5-pentanediol, 1,2,6-hexanetriol, and the like; bis(2-hydroxyethyl)sulfone; lower alkyl ether acetates such as polyethylene glycol monomethyl ether acetate and the like; polyhydric alcohol alkyl ethers such as ethylene glycol monomethyl (or -ethyl)ether, diethylene glycol methyl (or -ethyl)ether, triethylene glycol monomethyl (or -ethyl)ether, and the like; N-methyl-2-pyrrolidone; 2-pyrrolidone; 1,3-dimethyl-2-imidazolidinone; and the like. These water-soluble organic solvents can be used singly or as a mixture of two or more kinds thereof, as necessary. Of course, the water-soluble organic solvent in the present embodiment is not limited to the specific examples above.

Moreover, the content (% by mass) of the water-soluble organic solvent in the ink composition is preferably 5.0% by mass or more and 30.0% by mass or less, and more preferably 10.0% by mass or more and 30.0% by mass or less, based on the total mass of the ink composition. If the content of water is less or more than the range, that is, the content of the water-soluble organic solvent is out of the range, reliability such as intermittent discharging stability and the like are not typically obtained in the case of using the ink composition in an ink jet recording apparatus.

Further, in the ink composition according to the present embodiment, 1,2-alkylene glycol in which an alkylene group has 5 to 7 carbon atoms may further contain at least one diol selected from the group consisting of 1,2-pentanediol, 1,2-hexanediol, and 1,2-octanediol in an amount of 1.0% by mass or more and less than 4.0% by mass, based on the total mass of the ink composition.

### 2.8. Other Additives

With the ink composition according to the present embodiment, additives such as various defoaming agents, pH adjusters, fungicides, and the like may be added to the solvent.

The defoaming agent is used in order to prevent the ink composition from bubbling, and specific examples of the defoaming agent include organic defoaming agents such as silicon-based defoaming agents, surfactants, polyethers, higher alcohols, and the like. Further, in the case where the surfactant is used as a defoaming agent, a pol-yglycol-based non-ionic surfactant (commercially available products thereof include Antifroth F233 manufactured by Dai-ichi Kogyo Seiyaku Co., Ltd.) is preferably used.

As the pH adjuster, sodium salts, potassium salts, amines, or the like can be used. Examples of the sodium salts and the potassium salts include sodium hydroxide, potassium hydroxide, lithium hydroxide, sodium carbonate, sodium bicarbonate, potassium carbonate, lithium carbonate, sodium phosphate, potassium phosphate, lithium phosphate, potassium dihydrogen phosphate, dipotassium hydrogen phosphate, sodium oxalate, potassium oxalate, lithium oxalate, sodium borate, sodium tetraborate, potassium hydrogen phthalate, potassium hydrogen phthalate, and the like. Further, as the amines, ammonia, methylamine, ethylamine, diethylamine, tris(hydroxymethyl)aminomethane hydrochloride, triethanolamine, morpholine derivatives, propanolamine, and the like are preferably used. The same pH adjuster as above contributes to the dissolution stability or permeability of the colorant in the ink composition, while giving an effect on deterioration of the heating element (heater) of a thermal print head. From such a viewpoint, the content of the pH adjuster is preferably 0.10% by mass or more and less than 0.50% by mass, based on the total mass of the ink composition. If the content of the pH adjuster is less than 0.10% by mass, the pH is not sufficiently controlled in some cases. Further, a content of the pH adjuster of 0.50% by mass or more accelerates the deterioration of the heater or gives an adverse effect on the intermittent discharging stability in some cases. Further, taking into consideration of stability, in addition to the purpose of improvement of the dissolution stability or the permeability of the colorant, it is preferable that the pH adjuster be added to adjust the pH of the ink composition in the range of 6.0 to 9.0.

Furthermore, in the present embodiment, among the various pH adjusters as described above, 3-morpholinopropane sulfonic acid (MOPS) which is a morpholine derivative is particularly preferably used. By using MOPS, cogation of the heating element does not easily occur and the lifespan of the heating element can be increased.

As the fungicide, for example, organic nitrogen/sulfur-based compounds such as thiabendazole, cyabendazole, and the like can be used, in addition to sodium benzoate, potassium sorbitrate and benzoimidazole.

Furthermore, as a constituting component of the ink composition according to the present embodiment, alcoholamines such as monotriethanolamine, ditriethanolamine, and the like, and amides such as dimethylformamide, dimethylketoneamide, and the like can be suitably used. These alcoholamines, amides, or the like are used to obtain a pH adjusting effect or a moisturizing effect.

Moreover, the ink composition according to the present embodiment can include at least one humectant selected from water-soluble organic solvents having a lower vapor pressure than purified water, and sugars. As the humectant, for example, trimethylolpropane, urea, or the like can be used, in addition to xylitol. By incorporating the humectant into the ink composition, when the ink composition according to the present embodiment is used in the ink jet recording method, evaporation of the moisture can be suppressed so as to moisturize the ink. Further, if the water-soluble organic solvent is used as a humectant, the discharging stability can be improved or the viscosity of the ink composition can be modified while not changing the characteristics of the ink.

### 2.9. Method for Preparing Ink Composition

The above-described ink jet ink composition according to the present embodiment can be prepared as follows. First, the first color material represented by the general formula (I), the second color material represented by the general formula (II), the acetylene glycol-based surfactant represented by the general formula (III), and other additives are weighed to predetermined concentrations and added to a solvent. Here, it is preferable to control the contents or content ratios of the color materials to the above-described ranges.

Next, by sufficiently stirring a solution obtained by adding the color materials, the surfactants, and the like to a solvent, and then filtering it through a PTFE membrane-disc filter having a pore diameter of 0.45 μm, the ink jet ink composition according to the present embodiment can be obtained.

### 3. INK JET RECORDING METHOD ACCORDING TO SUITABLE EMBODIMENT OF THE DISCLOSURE

The ink jet recording method according to a suitable embodiment of the present disclosure is a method in which liquid droplets of the ink composition are discharged by an ink jet system to perform recording on a recording medium. The ink jet recording method according to the present embodiment may be one of a continuous ejection type or an on-demanded type. The continuous ejection type is a general term for types in which ink droplets are continuously ejected from a recording head, irrespective of the image signal (dot formation signal), and only the ink droplets used for recording reach the recording medium. The on demanded type is a general term for types in which ink droplets are discharged from a recording head to a recording medium according to an image signal.

Furthermore, examples of the on-demanded type of the ink jet recording method include a recording method involving applying mechanical energy to ink to discharge the ink droplets, a recording method involving applying thermal energy to ink to discharge the ink droplets, and the like. Examples of the recording method involving applying mechanical energy to ink include a piezo ink jet system in which ink droplets are discharged using a reverse piezoelectric effect of a piezoelectric body typified by PZT (lead zirconate titanate), an electrostatic suction system in which electrically charged ink is sucked onto a recording medium with an electrostatic force, and the like. It is particularly preferable to use an ink jet recording method using thermal energy (thermal ink jet system), as the ink jet recording method according to the present embodiment.

### 3.1. Usable Ink

In the ink jet recording method according to the present embodiment, the ink jet ink composition according to a suitable embodiment of the present disclosure as described above is used as an ink composition.

### 3.2. Usable Recording Medium

In the ink jet recording method according to the present embodiment, any recording medium on which recording is performed by applying the ink thereon can be used as (a) recording medium (media) used for formation of an image. In the present embodiment, it is preferable to use an ink jet recording medium in which color materials such as a dye, a pigment, and the like are adsorbed on a fine particle which forms a porous structure of an ink-receiving layer. It is particularly preferable to use a recording medium having a so-called gap absorption type ink-receiving layer, which absorbs ink by a gap formed in the ink-receiving layer on the support. The gap absorption type ink-receiving layer is mainly composed of fine particles and may further contain a binder and any other additive, as necessary.

As the fine particle mainly composing the gap absorption type ink-receiving layer, specifically, an inorganic pigment or an organic pigment can be used. Examples of the inorganic pigment include silica, clay, talc, calcium carbonate, kaolin, aluminum oxide such as alumina, alumina hydrate, and the like, diatomaceous earth, titanium oxide, hydrotalcite, zinc oxide, and the like. Examples of the organic pigment include a urea formalin resin, an ethylene resin, a styrene resin, and the like. These fine particles can be used singly or in combination of two or more kinds thereof, as necessary.

In particular, when an image is formed using the ink composition according to the present embodiment, it is preferable to use a recording medium having formed thereon an ink-receiving layer mainly composed of fine particles having an average particle diameter of 1 μm or less. Specific examples of the fine particles include silica fine particles typified by colloidal silica, aluminum oxide fine particles, alumina hydrate fine particles (alumina-based pigments), and the like.

Among the above alumina-based pigments, alumina hydrate such as pseudoboehmite represented by the following formula, and the like can be particularly mentioned as a suitable one:

AlO₃₋ₙ(OH)₂ₙ.mH₂O

(wherein n is an integer of 1 to 3, and m is 0 to 10, and preferably 0 to 5, provided that m and n are not simultaneously 0).

In many cases, mH₂O also represents an eliminable aqueous phase which does not participate in the formation of mH₂O crystal lattices. For this reason, m may take one of an integer and a value which is not an integer. Further, when this type of alumina hydrate is heated, m may reach 0. The alumina hydrate can be prepared by an existing method as follows. For example, it can be prepared by hydrolysis of aluminum alkoxide and sodium aluminate as described in U.S. Pat. No. 4,242,271 and U.S. Pat. No. 4,202,870. In addition, it can be prepared by a method in which an aqueous solution of one of sodium sulfate and aluminum chloride is added to an aqueous solution of sodium aluminate to effect neutralization as described in Japanese Examined Patent Application Publication No. 57-044605.

As the binder included in the gap absorption type ink-receiving layer, a water-soluble polymer, a latex, or the like can be used. Examples of the water-soluble polymer, the latex, and the like include polyvinyl alcohol, starch, gelatin, or modified products thereof; gum arabic; cellulose derivatives such as carboxymethyl cellulose, hydroxyethyl cellulose, hydroxyproylmethyl cellulose, and the like; vinyl-based copolymer latexes such as an SBR latex, an NBR latex, a methyl methacrylate-butadiene copolymer latex, a functional group-modified polymer latex, an ethylene-vinyl acetate copolymer, and the like; polyvinyl pyrrolidone; maleic anhydride or a copolymer thereof; an acrylic ester copolymer; and the like. These binders can be used singly or in combination of two or more kinds thereof.

As the additive included in the gap absorption type ink-receiving layer, a dispersant, a thickener, a pH adjuster, a lubricant, a fluidity denaturing agent, a surfactant, a defoaming agent, a releasing agent, a fluorescent brightener, an ultraviolet ray absorber, an antioxidant, a dye fixing agent, or the like can be used.

The recording medium used in the ink jet recording method according to the present embodiment preferably has a support for supporting the above-described ink-receiving layer. Any support can be used without any particular limitation as long as its ink-receiving layer can be formed of the above-described porous fine particles and the support provides rigidity such that the support can be transported by a transport system of an ink jet printer or the like. Specific examples thereof include a paper support formed of a pulp raw material mainly composed of natural cellulose fibers; a plastic support composed of a material such as polyesters (for example, polyethylene terephthalate), cellulose triacetate, polycarbonate, polyvinyl chloride, polypropylene, polyimide, and the like; and resin-coated paper (for example, RC paper) having, on at least one side of a base paper, a polyolefin resin-coated layer added with a white pigment or the like.

Furthermore, in the present embodiment, the pH of the surface of the recording medium is preferably 3.0 or more and 8.0 or less. Further, in order to sufficiently obtain an effect in the case where the ink composition according to the present embodiment is used, that is, an effect of obtaining an image having excellent fastness with a high image quality, and the like, the pH of the surface of the recording medium is particularly preferably 4.0 or more and 6.0 or less.

### 4. INK CARTRIDGE ACCORDING TO SUITABLE EMBODIMENT OF THE DISCLOSURE

The ink cartridge according to a suitable embodiment of the present disclosure include an ink-storing unit for storing ink, and uses the ink jet ink composition according to the present embodiment as described above as the ink. In the ink-storing unit, an ink-storing unit for storing each ink of yellow, magenta, and cyan may be further provided, in addition to storing the ink composition (black ink) according to the present embodiment. Further, specific examples of the ink cartridge will be described later.

### 5. RECORDING UNIT ACCORDING TO SUITABLE EMBODIMENT OF THE DISCLOSURE

The recording unit according to a suitable embodiment of the present disclosure includes an ink-storing unit for storing ink and a recording head for discharging the ink stored in the ink-storing unit, in which the above-described ink jet ink composition according to the present embodiment is used as the ink. In particular, with the suitable recording head which is suitable for performing recording using the ink composition according to the present embodiment, a thermal ink jet type recording unit in which ink droplets are discharged by applying thermal energy corresponding to an image signal to the ink can be used. Among these recording units, in the present embodiment, it is particularly preferable to use a recording head having a wetted surface of a heating unit containing at least one of a metal and a metal oxide. Examples of the metal or metal oxide constituting the wetted surface of a heating unit include metals such as Ta, Zr, Ti, Ni, Al, and the like, or oxides of the metals, and the like. Further, specific examples of the recording unit will be described later.

### 6. INK JET RECORDING APPARATUS ACCORDING TO SUITABLE EMBODIMENT OF THE DISCLOSURE

### 6.1. Overview of Ink Jet Recording Apparatus

The ink jet recording apparatus according to a suitable embodiment of the present disclosure includes an ink-storing unit for storing ink and a recording head for discharging the ink stored in the ink-storing unit, and uses the above-described ink jet ink composition according to the present embodiment as the ink. The ink jet recording apparatus according to the present embodiment has a system for supplying and delivering the recording medium, a system for transporting the recording medium, a system for maintaining the maintenance of the recording head, and the like, in addition to a recording unit including an ink-storing unit and a recording head.

In particular, as an ink jet recording apparatus suitable for performing recording using the ink composition according to the present embodiment, a thermal ink jet type of an ink jet recording apparatus, in which ink droplets are discharged by applying thermal energy corresponding to an image signal to the ink.

### 6.2. Specific Constitution Examples of Ink Jet Recording Apparatus

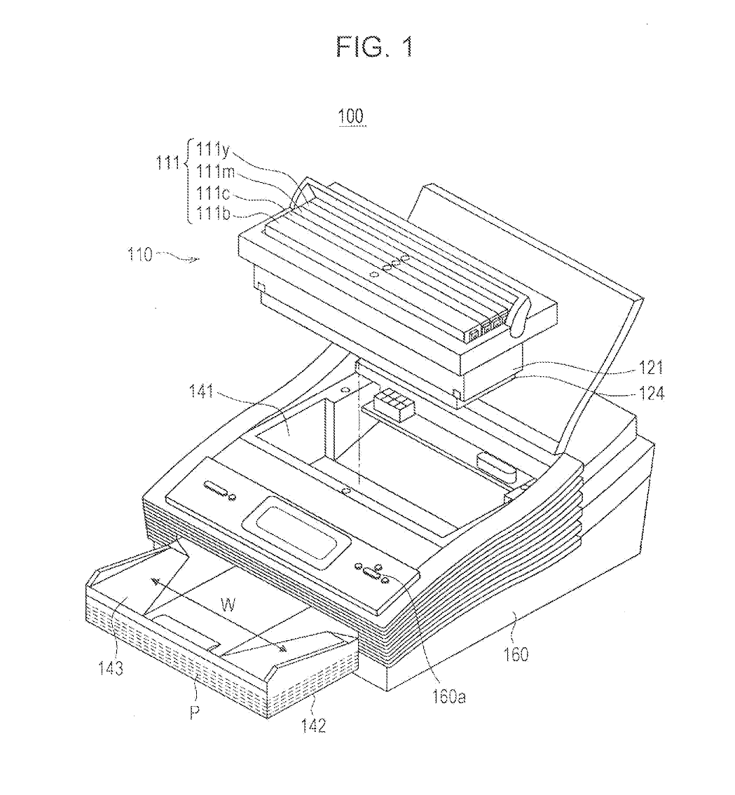

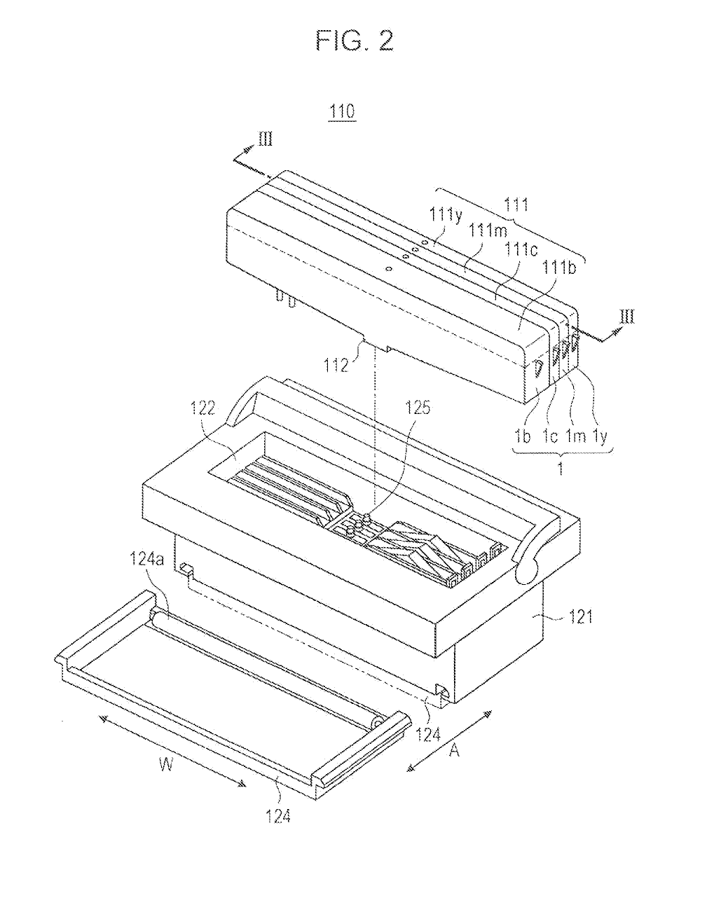

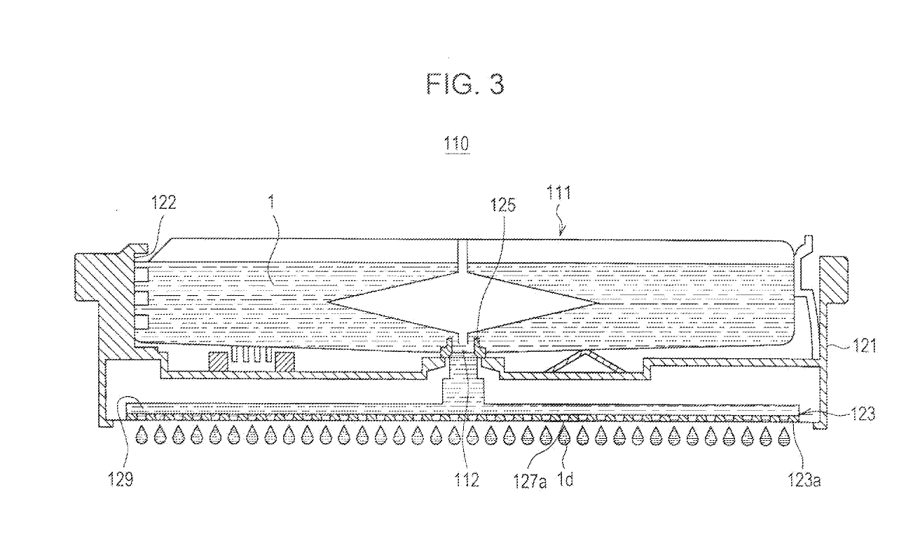

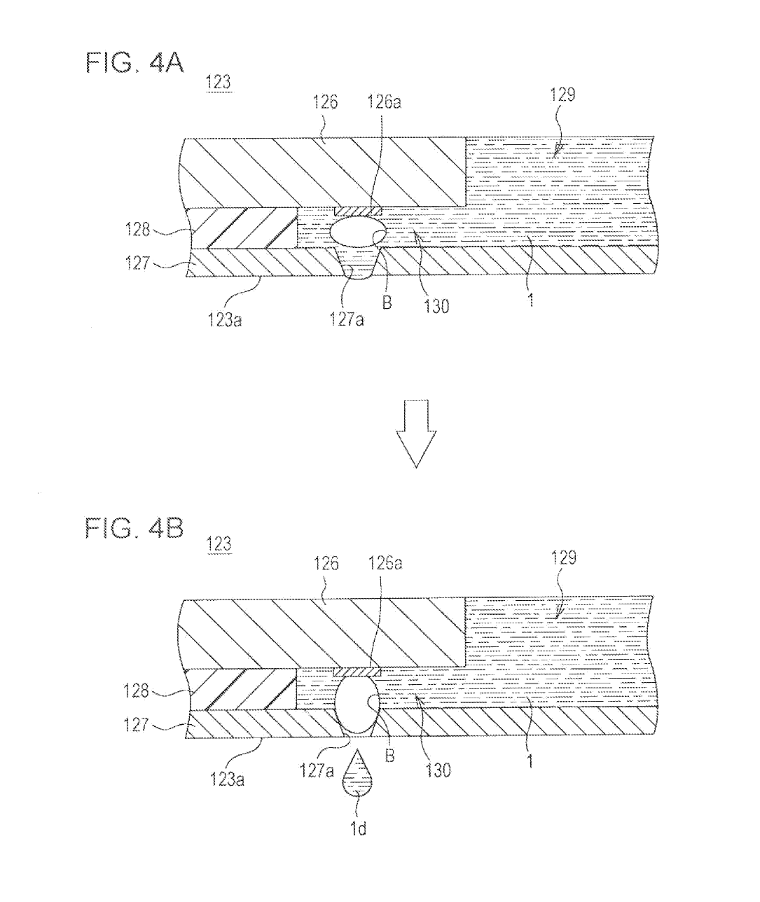

Here, with reference to FIGS. 1 to 4, a specific constitution of the ink jet recording apparatus according to the present embodiment will be described, citing a line type of an ink jet recording apparatus 100 having a recording head (line head) in which a plurality of nozzles are arranged substantially linearly along the width direction of the recording medium, as one example of the ink jet recording apparatus according to the present embodiment. Further, FIG. 1 is an exploded perspective view showing an example of the entire constitution of the ink jet recording apparatus according to a suitable embodiment of the present disclosure. FIG. 2 is an exploded perspective view showing an example of the constitution of the head cartridge provided in the ink jet recording apparatus 100 of FIG. 1. FIG. 3 is a cross-sectional view obtained by cutting the head cartridge shown in FIG. 2 along the line. FIGS. 4A and 4B is a cross-sectional view showing the constitution of the recording head provided in the head cartridge shown in FIG. 3, in which (a) schematically shows the state of the bubbles generated on the heating element and (b) schematically shows the state of ink droplets discharged from the nozzle.

In the ink jet recording apparatus 100 shown in FIG. 1, the ink composition according to the present embodiment is used as a magenta ink 1m, and used in combination with a cyan ink 1c, a yellow ink 1y, and a black ink 1b, which have other colors, to form a color image or letter as recorded matter. Further, in the description below, the magenta ink 1m, the cyan ink 1c, the yellow ink 1y, and the black ink 1b are collectively referred to as an ink 1 simply in some cases.

As shown in FIG. 1, the ink jet recording apparatus 100 is a so-called line type of an ink jet recording apparatus, in which one or more rows of nozzles for discharging ink droplets in the width direction of the recording medium (for example, recording paper P), that is, in the direction of an arrow W in FIG. 1, are arranged substantially linearly. This ink jet recording apparatus 100 includes an ink jet printer head cartridge (hereinafter referred to as a “head cartridge”) 110 and an apparatus main body 160.

(6.2.1. Constitution of Head Cartridge)

The head cartridge 110 is detachably provided in the apparatus main body 160, and for example, in order to apply thermal energy corresponding to an image signal to the ink, the ink 1 is discharged using a heating resistor as a heating element and the ink 1 is landed onto the surface of the recording paper P. On the head cartridge 110, an ink cartridge 111 storing the ink 1 is mounted, as shown in FIGS. 2 and 3.

[Ink Cartridge]

The ink cartridge 111 includes four ink cartridges 111m, 111c, 111y, and 111b corresponding to the magenta ink 1m, the cyan ink 1c, the yellow ink 1y, and the black ink 1b, respectively. That is, the ink cartridge 111m includes an ink-storing unit storing the ink composition according to the present embodiment as the magenta ink 1m. In a similar way, the ink cartridges 111c, 111y, and 111b include ink-storing units corresponding to the cyan ink 1c, the yellow ink 1y, and the black ink 1b, respectively. Further, the dimension in the length direction of the ink cartridge 111 is substantially the same as that in the width direction of the recording paper P, and the horizontal cross-section is formed to have a substantially rectangular shape. In addition, the ink cartridge 111 includes an ink supply unit 112 for supplying the ink 1 to the cartridge main body 121 of the head cartridge 110.

The ink supply unit 112 is provided at an approximate center part of the bottom surface of the ink cartridge 111. The ink supply unit 112 is a nozzle formed to protrude from the bottom surface of the ink cartridge 111, and by fitting the edge of the nozzle into the connection unit 125 of the head cartridge 110 described later, the ink cartridge 111 and the cartridge main body 121 of the head cartridge 110 are connected. Thus, the connection of the ink cartridge 111 with the cartridge main body 121 makes it possible to supply the ink 1 from the ink cartridge 111 to the cartridge main body 121. Further, in the ink supply unit 112, a valve system (not shown) for adjusting the amount of the ink 1 supplied from the ink cartridge 111 to the cartridge main body 121 is provided. Further, the ink cartridge 111 may be formed physically integrally with the cartridge main body 121.

[Cartridge Main Body]

The head cartridge 110 includes the cartridge main body 121 on which the ink cartridge 110 is mounted, in addition to the above-described ink cartridge 111. The cartridge main body 121 has a mounting unit 122 on which the ink cartridge 111 is mounted, a recording head 123 for discharging the liquid droplets of the ink 1 (hereinafter described as the “ink droplets 1d”), and a head cap 124 for protecting the recording head 123.

A connection unit 125, which is connected to the ink supply unit 112 of the ink cartridge 111 mounted on the mounting unit 122, is provided at an approximate center part in the length direction of the mounting unit 122. This connection unit 125 is an ink supply path for supplying the ink 1 from the ink supply unit 112 of the ink cartridge 111 mounted on the mounting unit 122 to the recording head 123 for discharging the ink droplets 1d provided on the bottom surface of the cartridge main body 121. In addition, in the connection unit 125, a valve system (not shown) for adjusting the amount of the ink 1 supplied from the ink cartridge 111 to the recording head 123 is provided.

The recording head 123 is provided on the bottom surface of the cartridge main body 121 and has a plurality of nozzles 127a (the details of which will be described later). A plurality of these nozzles 127a are discharging openings for discharging the liquid droplets of the ink 1 supplied from the connection unit 125, and are arranged substantially linearly in the width direction of the recording paper P, that is, in the direction of an arrow w in FIG. 3. Further, the nozzles 127a are provided, corresponding to each color of magenta, cyan, yellow, and black, and constitute a nozzle line of magenta, a nozzle line of cyan, a nozzle line of yellow, and a nozzle line of black. More, the nozzle lines of the respective colors are arranged to be aligned in the direction approximately perpendicular to the width direction of the recording paper P. The recording head 123 can discharge the ink droplets 1d in each nozzle line without moving in the width direction of the recording paper P, from the viewpoints of having the constitution as described above.

Furthermore, as shown in FIGS. 4A and 4B, in the recording head 123, a circuit substrate 126 provided with electrothermal conversion type of heating resistors 126a and a plurality of nozzles 127a are formed. Further, in the recording head 123, a nozzle sheet 127 formed with a thin metal film such as a nickel-plated film and the like, and an ink flow path 129 for supplying the ink 1 supplied from the connection unit 125 to each of the nozzles 127a by a film 128 provided between the circuit substrate 126 and the nozzle sheet 127, are formed. This ink flow path 129 is formed such that the length direction is a direction in which the nozzles 127a are arranged, that is, a direction of an arrow W in FIG. 3. By this, in the recording head 123, the ink 1 flows from the ink cartridge 111 into the ink flow path 129 via the connection unit 125 of the head cartridge 110, and the ink 1 is supplied from the ink flow path 129 to each of the nozzles 127a. Further, in the recording head 123, an ink liquid chamber 130 surrounded with the circuit substrate 126, the nozzle sheet 127, and the film 128, in which the heating resistors 126a pressurizes the ink 1, is formed.

In the recording head 123 having the constitution as described above, an image signal generated based on the print data is transferred to the circuit substrate 126, and a pulsed electrical current is supplied for a predetermined time (for example, about 1 to 3 μsec) to the heating resistors 126a selected according to the image signal. In the recording head 123 to which the pulsed electrical current is supplied, the heating resistors 126a are driven and rapidly heated. At this time, in the recording head 123, when the heating resistors 126a are heated, bubbles B are generated in the ink 1 in contact with the heating resistors 126a, as shown in FIG. 4A. Next, in the recording head 123, bubbles B pressurize the ink 1 during expansion and the ink 1 pressurized by the bubbles B is brought into the state of liquid droplets and discharged from the nozzles 127a, as shown in FIG. 4B. Further, in the recording head 123, the ink droplets 1d are discharged, and the ink 1 is then supplied from the ink cartridge 111 to the ink liquid chamber 130 through the ink flow path 129 via a connection unit 125, thereby returning to the state before discharging. In the recording head 123, the above-described operations are repeated according to the image signal, and the ink droplets 1d are discharged on the recording paper P to form an image.

In the present embodiment, the head cartridge 110 has a head cap 124 for protecting the ink discharging surface 123a of the recording head 123. The head cap 124 obstructs the discharging surface 123a of the recording head 123 and protects the nozzle 127a from drying or the like, while the recording head 123 does not discharge the ink droplets 1d and does not carry out the recording operation, as shown in FIG. 2. When carrying out the recording operation, the head cap 124 moves from the bottom surface of the head cartridge 110 to the front surface side of the apparatus main body 160, and the discharging surface 123a is exposed to the outside and opened, as shown in FIG. 2. Further, in the head cap 124, a cleaning roller 124a for removing extra ink 1 attached on the discharging surface 123a is provided. In the head cap 124, when the discharging surface 123a is opened, the discharging surface 123a is cleaned by the cleaning roller 124a.

(6.2.2. Constitution of Apparatus Main Body)

The apparatus main body 160 has a head cartridge mounting unit 161, a paper feed tray 162, a paper delivery tray 163, a paper feed and delivery system (not shown), a head cap opening and closing system (not shown), as shown in FIG. 1. The head cartridge mounting unit 161 is provided on the top surface side of the apparatus main body 160, on which the head cartridge 110 is mounted. The paper feed tray 162 is provided on the lower side of the front surface of the apparatus main body 160, and the recording paper P before recording, such as an image and the like, is laminated and stored. The paper delivery tray 163 is provided on the upper side of the front surface of the apparatus main body 160, and the recording paper P after recording, such as an image and the like, is laminated and stored. Further, the paper feed and delivery system is a system for transporting the recording paper P in the apparatus main body 160, and the head cap opening and closing system is a system for opening and closing the head cap 124, that is, for moving the head cap 124 so as to open or close the discharging surface 123a of the recording head 123.

(6.2.3. Operation of Ink Jet Recording Apparatus)

The ink jet recording apparatus 100 having the constitution as described above generates a control signal for controlling the operation of the paper feed and delivery system, the head cap opening and closing system, and the recording head 123, according to the print data input from an information processing apparatus provided in the outside. This control signal is generated by a control unit provided in a control circuit which controls the supply of the electrical current to the paper feed and delivery system, the head cap opening and closing system, and the recording head 123. Further, by supply the electrical current controlled by a control signal to the paper feed and delivery system, the head cap opening and closing system, and the recording head 123, the operations such as the paper feed and delivery of the recording paper P, opening and closing of the head cap 124, and discharging of the ink droplets 1d by the recording head 123, and the like are carried out.

More specifically, in the ink jet recording apparatus 100, first, a print start is ordered of the control unit by the operation of an operation button 160a provided in the apparatus main body 160, the paper feed and delivery system and the head cap opening and closing system are driven by the control signal transferred to the driving control unit to become ready for printing. That is, the head cap opening and closing system moves the head cap 124 to the front surface side of the apparatus main body 160, which is a side having the paper feed tray 162 and the paper delivery tray 163 provided thereon, with respect to the head cartridge 110. This cause the nozzles 127a provided in the discharging opening 123a of the recording head 123 to be brought into an open state to be exposed to the outside, and thus, the recording head 123 can discharge the ink 1.

Next, the paper feed and delivery system takes out only one sheet of recording paper P from the paper feed tray 162 and transports the recording paper P to a position opposite to the discharging surface 123a of the recording head 123. Thus, the recording paper P becomes opposite to the discharging surface 123a.

Next, in the ink jet recording apparatus 100, the driving electrical current is supplied to the heating resistors 126a selected by a control signal according to the print data in a plurality of the heating resistors 126a provided in the recording head 123, and the selected heating resistors 126a are heated. In the ink jet recording apparatus 100, the ink droplets 1d are discharged by the nozzle 127a corresponding to the heated heating resistors 126a to the recording paper P transported to a position opposite to the discharging surface 123a, as shown in FIGS. 4A and 4B, by heating the heating resistors 126a, thereby recording an image, a letter, or the like.

Next, in the paper feed and delivery system, the recording paper P in which recording of an image, a letter, or the like is completed is fed and transported to the paper delivery tray 163 and the recording paper P after recording is delivered to the paper delivery tray 163. Thus, in the ink jet recording apparatus 100, recording of an image, a letter, or the like is performed in the recording paper P. After recording, the head cap opening and closing system moves the head cap 124 waiting on the front surface side of the apparatus main body 160 to the bottom surface of the head cartridge 110, and obstructs and protects the discharging surface 123a of the recording head 123. In addition, at this time, the discharging surface 123a may be cleaned by the cleaning roller 124a.

### 7. CONCLUSION

As described above, the ink composition according to the present embodiment is intended to solve the problems occurring in the case of the combined use of the azo dye of the general formula (I) and the acetylene glycol-based surfactant of the general formula (III). Specifically, by the addition of the anthrapyridone dye of the general formula (II) to the ink composition including the dye and the surfactant, the surface-active performance can be sufficiently exerted while not increasing the content of the surfactant of the general formula (III).

Therefore, according to the present embodiment, an ink jet ink composition, which is capable of recording recorded matter having excellent fastness with a high image quality and has excellent intermittent discharging stability. In particular, as for the intermittent discharging property, a good image can be obtained stably even during a printing pause time of 5 seconds or longer, and in a further preferable embodiment, 10 seconds or longer, as described in Examples described later. Further, according to the present embodiment, an ink jet ink composition having a preferable color tone as a magenta ink can be obtained. In addition, the ink jet ink composition according to the present embodiment has excellent durability for a heating element (heater) even when used in a thermal ink jet recording system.

Moreover, by the ink jet recording method, the ink cartridge, the recording unit, and the ink jet recording apparatus according to the present embodiment, an image having excellent fastness (excellent light resistance, and thus, superior storability) with a high image quality can be obtained stably by using the ink jet ink composition according to the present embodiment as a magenta ink.

### EXAMPLES

Hereinbelow, the present disclosure will be described in more detail with reference to Examples, but the present disclosure is not limited to Examples below.

<Preparation of Color Material>

[Synthesis of Exemplary Compounds 1 to 4]

Exemplary Compounds 1 to 4 were synthesized in accordance with the method described in Example 1 of Japanese Unexamined Patent Application Publication No. 2006-143989 above. Hereinbelow, the method for synthesizing the Exemplary Compound 1 will be described as a specific example.

(1) Synthesis of Compound 1-1

24.1 g of 5-amino-3-tert-butyl-4-cyanopyrazole (Compound A as described below) was added to a mixed solvent of 45 ml of concentrated hydrochloric acid, 30 ml of acetic acid, and 45 ml of propionic acid, and the mixture was stirred at an internal temperature of 0° C. Further, to the solution after stirring was added dropwise a solution of 10.1 g of sodium nitrite in 20 ml of water for 10 minutes, and the mixture was stirred as it was for 30 minutes.

Next, 84.7 g of a coupler component (Compound B as described below) was dissolved in a mixed solvent of 231 ml of methanesulfonic acid, 147 ml of acetic acid, and 221 ml of propionic acid, and the mixture was stirred at 0° C. To the solvent after stirring was added a reaction solution of the Compound A (diazonium salt) for 30 minutes. After addition of the diazonium salt, the reaction solution was stirred for an additional 30 minutes. Then, the reaction solution was slowly added to 2250 ml of water to which 750 g of ice had been added while stirring. The precipitated compound was isolated by suction filtration to obtain a Compound 1-1.

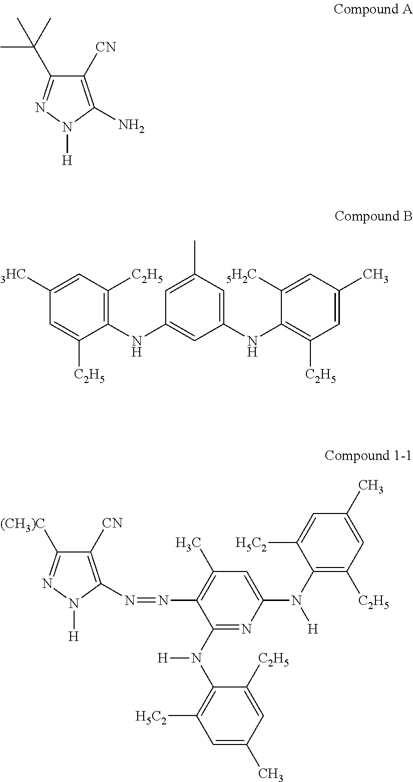

(2) Synthesis of Compound (Compound 1-2)

21 g of the Compound 1-1 was transferred to a container, and 26.6 g of a heterylating agent (Compound C as described below), 21.7 g of potassium carbonate, and 147 ml of DMSO (dimethyl sulfoxide) were added to the container. The mixture was heated and stirred at an internal temperature of 92° C. for 4 hours while bubbling nitrogen. After completion of the reaction, the solution inside was cooled to room temperature. The compound precipitated from the reaction system was isolated by suction filtration. Further, the crude crystals were dispersed in 3 L of water to dissolve excess potassium carbonate, and the mixture was filtered by suction to obtain a desired compound (Compound 1-2 as described below).

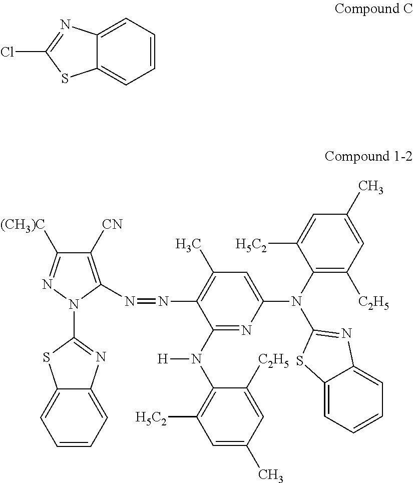

(3) Synthesis of Exemplary Compound 1

33 ml of a 30% by mass fuming sulfuric acid was cooled to 10° C., and 4.7 g of the Compound 1-2 was added in separate portions thereto at an internal temperature of 25° C. or lower. After performing a reaction at an internal temperature of 30° C. for 2.5 hours, the internal temperature was lowered to 0° C., and 24 ml of water and 42 ml of 28% by mass aqueous ammonia were added dropwise thereto in this order. After the dye was extracted with 26 ml of isopropanol/n-butanol (21:5), the pH was adjusted to 9 with a 25% by mass sodium hydroxide aqueous solution, and 20 ml of ethanol was added dropwise thereto. The precipitated inorganic salt was filtered off, and after the addition of 10 ml of methanol, 6.0 g of sodium acetate, and 2.4 g of potassium acetate, the internal temperature was raised to 65° C., and then 80 ml of ethanol was added dropwise thereto. Further, the reaction solution was cooled to room temperature and the precipitated crystals were extracted by filtration. The obtained crystals were dissolved in 36 ml of water and the solution was charged in a cylindrical column packed with 50 ml of a sodium type of a strong acid cation exchange resin (a resin obtained by converting Amberlite IR-120B, trade name, manufactured by Organo Corporation, to a sodium type). The solution was passed through the packed column at 25° C. and a flow rate of about SV4. The pH of the passed aqueous solution was adjusted to 7 with a dilute aqueous lithium hydroxide solution, and the aqueous solution was filtered through a membrane filter having an average pore diameter of 0.22 μm. The filtrate was concentrated, dried, and solidified under reduced pressure, and then dried at 70° C. overnight to obtain an Exemplary Compound 1.

[Synthesis of Exemplary Compounds 5 to 8]

The Exemplary Compounds 5 to 7 were synthesized in accordance to the method described in Example 2 of Japanese Unexamined Patent Application Publication No. 10-306221. Further, the Exemplary Compound 8 was synthesized in accordance to the method described in Example 1 of Japanese Unexamined Patent Application Publication No. 2009-191147. Hereinbelow, the methods for synthesizing Exemplary Compounds 5 and 6 will be described as a specific example.

(1) Synthesis of Compound 5-1

25.7 g of 1-methylamino-4-(3-methylanilino)anthraquinone (Compound D as described below), 0.75 g of sodium carbonate, 30.0 g of diethyl malonic ester, and 45 g of orthodichlorobenzene were put into a reactor and allowed to undergo a reaction at 175 to 180° C. for 5 hours. The reaction was performed while ethanol and water thus produced were discharged therefrom. After confirming the completion of the reaction by means of HPLC (High Performance Liquid Chromatography), the mixture was cooled with water and 170 ml of methanol was added thereto. The mixture was further stirred for 1 hour and the precipitated crystals were filtered. Then, the obtained crystals were washed with 225 ml of methanol, washed with 180 ml of purified water at 80° C., and then dried to obtain a Compound 5-1 below as a purplish red crystal.

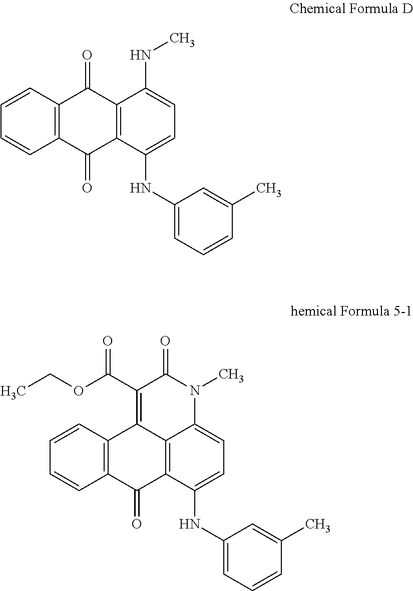

(2) Synthesis of Exemplary Compound 5

31.0 g of 96% by mass sulfuric acid was put into a reactor, and 33.4 g of 30% by mass fuming sulfuric acid was added thereto under ice-cooling to prepare a 7% by mass fuming sulfuric acid. To this fuming sulfuric acid was added 8.8 ml of the Compound 5-1 at 20° C. under ice-cooling and allowed to undergo a sulfonation reaction at a temperature of 20 to 25° C. for 3 hours. To 400 ml of purified water at 0° C. was added the above-described reaction solution, and 60 g of the sodium chloride to perform salting out. Further, after stirring for 2 hours, filtration was performed using a membrane filter having an average pore diameter of 0.22 μm. The filtrate was concentrated, dried, and solidified under reduced pressure, and then dried at 70° C. overnight to obtain an Exemplary Compound 5.

Furthermore, the Exemplary Compound 5 obtained above was dissolved in water, acidified by the addition of an acid, and filtered. The cake thus obtained was dissolved in water again, and lithium hydroxide was added thereto to obtain an Exemplary Compound 6 as a lithium salt.

<Preparation of Ink>

For all the ink compositions, a colorant which was selected from the Exemplary Compounds 1 to 8 obtained above, the following Comparative Compound 1, the following Comparative Compound 2, and C. I. Direct Black 154 was used as a color material.

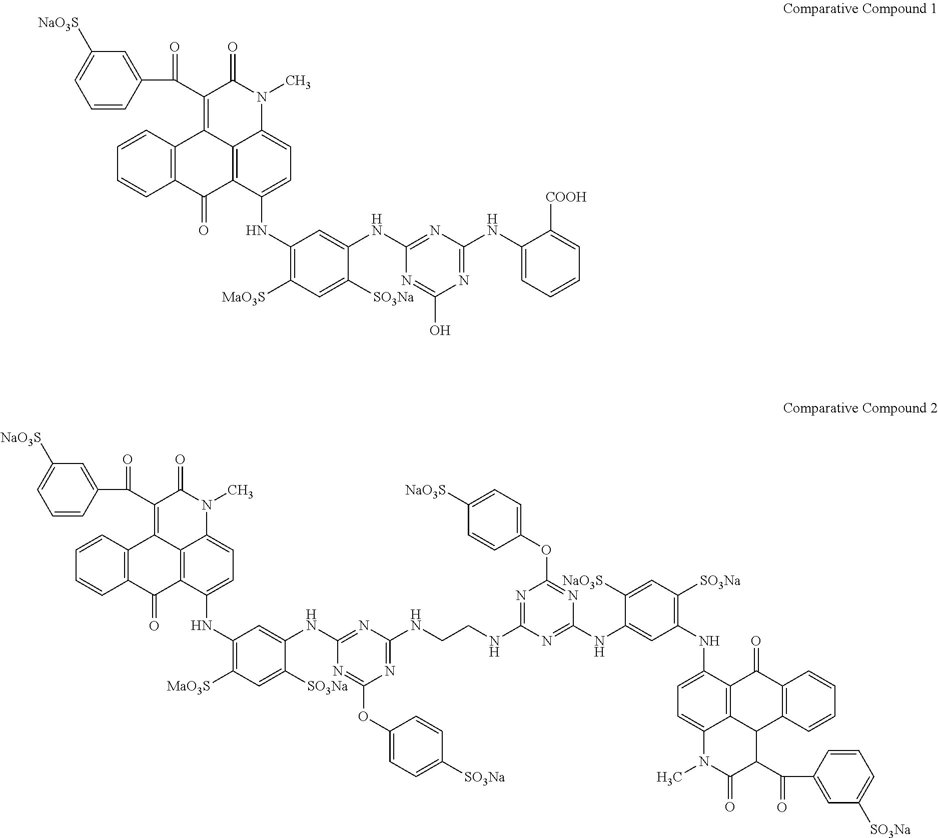

The ink compositions in Examples were prepared in accordance with the preparation method of Example 1 shown below such that the respective components were at the content ratios (% by mass) described at the upper parts of Tables 1-1 to 1-3, and the ink compositions in Comparative Examples were prepared in accordance with the preparation method of Example 1 shown below such that the respective components were at the content ratios (% by mass) described at the upper parts of Tables 2-1 to 2-2.

Further, in the lower parts of Tables 1-1 to 1-3 and Tables 2-1 to 2-2, the total content of the dyes in the ink composition (dye concentration) and the ratios of the azo compound/the anthrapyridone compound in the ink composition were described as the characteristics of each ink.

### Preparation of Ink Composition of Example 1

Based on the total amount of the ink composition, the Exemplary Compound 1 as a first color material represented by the general formula (I) was weighed to a concentration of 3.2% by mass, the Exemplary Compound 5 as a second color material represented by the general formula (II) was weighed to a concentration of 0.8% by mass, Surfynol E1010 (manufactured by Nissin Chemical Industry Co., Ltd.) as an acetylene glycol-based surfactant of the general formula (III) was weighed to concentration of 0.1% by Mass, glycerin was weighed to concentration of 2.0% by mass, 1,5-pentanediol was weighed to concentration of 10.0% by mass, 1,2-pentanediol was weighed to concentration of 3.0% by mass, xylitol was weighed to concentration of 1.0% by mass, and these were added to ion exchange water, followed by mixing.

The solution was sufficiently stirred and then filtered through a filter having a pore diameter of 0.5 μm to obtain an ink composition of Example 1.

TABLE 1-1
(units of the components shown in Table: % by mass)

| | | Example | | | | | |
|---|---|---|---|---|---|---|---|
| Name of components | | 1 | 2 | 3 | 4 | 5 | 6 |
| Azo compound | Exemplary Compound 1 | 3.2 | 3.2 | 3.2 | 3.2 | 2.0 | 2.0 |
| General | Exemplary Compound 2 | | | | | | |
| formula (I) | Exemplary Compound 3 | | | | | | |
| | Exemplary Compound 4 | | | | | | |
| Anthrapyridone | Exemplary Compound 5 | 0.8 | 0.8 | 0.8 | 0.8 | 2.0 | 2.0 |
| compound | Exemplary Compound 6 | | | | | | |
| General | Exemplary Compound 7 | | | | | | |
| formula (II) | Exemplary Compound 8 | | | | | | |
| | Comparative Compound 1 | | | | | | |
| | Comparative Compound 2 | | | | | | |

| | | | | | | |
|---|---|---|---|---|---|---|
| C.I. Direct Red 52 | | | | | | |
| Glycerin | 2.0 | 2.0 | 2.0 | 2.0 | 2.0 | |
| 1,5-Pentanediol | 10.0 | 10.0 | 10.0 | 10.0 | 10.0 | |
| 1,2-Pentanediol | 3.0 | 3.0 | 3.0 | 3.0 | 3.0 | |
| Ethylene glycol | | | | | | 9.0 |
| Diethylene glycol | | | | | | 9.0 |
| 2-Pyrrolidone | | | | | | |
| Trimethylolpropane | | | | | 3.0 | |
| Xylitol | 1.0 | 1.0 | 1.0 | 1.0 | | |
| Surfynol E1010 *1 | 0.1 | 0.3 | 0.5 | 0.7 | 0.5 | |
| Acetylenol E100 *2 | | | | | | 0.5 |
| Water | 79.9 | 79.7 | 79.5 | 79.3 | 77.5 | 77.5 |
| Dye concentration | 4.0 | 4.0 | 4.0 | 4.0 | 4.0 | 4.0 |
| Ratio of azo compound/anthrapyridone | 4.0 | 4.0 | 4.0 | 4.0 | 1.0 | 1.0 |
| compound | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 1-2
(units of the components shown in Table: % by mass)

| | | Example | | | | | |
|---|---|---|---|---|---|---|---|
| Name of Component | | 7 | 8 | 9 | 10 | 11 | 12 |
| Azo compound | Exemplary Compound 1 | 2.0 | 1.4 | 1.0 | 3.5 | 4.0 | 4.8 |
| General | Exemplary Compound 2 | | | | | | |
| Formula (I) | Exemplary Compound 3 | | | | | | |
| | Exemplary Compound 4 | | | | | | |
| Anthrapyridone | Exemplary Compound 5 | 2.0 | 2.6 | 3.0 | 0.5 | 1.0 | 1.2 |
| compound | Exemplary Compound 6 | | | | | | |
| General | Exemplary Compound 7 | | | | | | |
| Formula (II) | Exemplary Compound 8 | | | | | | |
| | Comparative Compound 1 | | | | | | |
| | Comparative Compound 2 | | | | | | |

| | | | | | | |
|---|---|---|---|---|---|---|
| C.I. Direct Red 52 | | | | | | |
| Glycerin | | 2.0 | 2.0 | 2.0 | 2.0 | 2.0 |
| 1,5-Pentanediol | 10.0 | 10.0 | 10.0 | 10.0 | 10.0 | 10.0 |
| 1,2-Pentanediol | | 3.0 | 3.0 | 3.0 | 3.0 | 3.0 |
| Ethylene glycol | | | | | | |
| Diethylene glycol | | | | | | |
| 2-Pyrrolidone | 7.0 | | | | | |
| Trimethylolpropane | | 3.0 | 3.0 | 3.0 | 3.0 | 3.0 |
| Xylitol | | | | | | |
| Surfynol E1010 *1 | | 0.5 | 0.5 | 0.5 | 0.5 | 0.5 |
| Acetylenol E100 *2 | 0.5 | | | | | 0.5 |
| Water | 78.5 | 77.5 | 77.5 | 77.5 | 77.5 | 77.5 |
| Dye concentration | 4.0 | 4.0 | 4.0 | 4.0 | 5.0 | 6.0 |
| Ratio of azo compound/anthrapyridone | 1.0 | 0.5 | 0.3 | 7.0 | 4.0 | 4.0 |
| compound | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 1-3
(units of the components shown in Table: % by mass)

| | | Example | | | | | |
|---|---|---|---|---|---|---|---|
| Name of Component | | 13 | 14 | 15 | 16 | 17 | 18 |
| Azo compound | Exemplary Compound 1 | | | 2.0 | 2.0 | 2.0 | |
| General | Exemplary Compound 2 | 2.0 | | | | | |
| Formula (I) | Exemplary Compound 3 | | 2.0 | | | | |
| | Exemplary Compound 4 | | | | | | 2.0 |
| Anthrapyridone | Exemplary Compound 5 | 2.0 | 2.0 | | | | 2.0 |
| compound | Exemplary Compound 6 | | | 2.0 | | | |
| General | Exemplary Compound 7 | | | | 2.0 | | |
| Formula (II) | Exemplary Compound 8 | | | | | 2.0 | |
| | Comparative Compound 1 | | | | | | |
| | Comparative Compound 2 | | | | | | |

| | | | | | | |
|---|---|---|---|---|---|---|
| C.I. Direct Red 52 | | | | | | |
| Glycerin | 2.0 | 2.0 | 2.0 | 2.0 | 2.0 | 2.0 |
| 1,5-Pentanediol | 10.0 | 10.0 | 10.0 | 10.0 | 10.0 | 10.0 |
| 1,2-Pentanediol | 3.0 | 3.0 | 3.0 | 3.0 | 3.0 | 3.0 |
| Ethylene glycol | | | | | | |
| Diethylene glycol | | | | | | |
| 2-Pyrrolidone | | | | | | |
| Trimethylolpropane | 3.0 | 3.0 | 3.0 | 3.0 | 3.0 | 3.0 |
| Xylitol | | | | | | |
| Surfynol E1010 *1 | 0.5 | 0.5 | 0.5 | 0.5 | 0.5 | 0.5 |
| Acetylenol E100 *2 | | | | | | |
| Water | 77.5 | 77.5 | 77.5 | 77.5 | 77.5 | 77.5 |
| Dye concentration | 4.0 | 4.0 | 4.0 | 4.0 | 4.0 | 4.0 |
| Ratio of azo compound/anthrapyridone | 1.0 | 1.0 | 1.0 | 1.0 | 1.0 | 1.0 |
| compound | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 2-1
(units of the components shown in Table: % by mass)

| | | Comparative Example | | | | | |
|---|---|---|---|---|---|---|---|
| Name of Component | | 1 | 2 | 3 | 4 | 5 | 6 |
| Azo compound | Exemplary Compound 1 | 3.2 | 3.2 | 2.0 | 2.0 | 4.0 | 3.2 |
| General | Exemplary Compound 2 | | | | | | |
| Formula (I) | Exemplary Compound 3 | | | | | | |
| | Exemplary Compound 4 | | | | | | |
| Anthrapyridone | Exemplary Compound 5 | 0.8 | 0.8 | 2.0 | 2.0 | | |
| compound | Exemplary Compound 6 | | | | | | |
| General | Exemplary Compound 7 | | | | | | |
| Formula (II) | Exemplary Compound 8 | | | | | | |
| | Comparative Compound 1 | | | | | | 0.8 |
| | Comparative Compound 2 | | | | | | |

| | | | | | | |
|---|---|---|---|---|---|---|
| C.I. Direct Red 52 | | | | | | |
| Glycerin | 2.0 | 2.0 | | | 2.0 | 2.0 |
| 1,5-Pentanediol | 10.0 | 10.0 | | 10.0 | 10.0 | 10.0 |
| 1,2-Pentanediol | 3.0 | 3.0 | | | 3.0 | 3.0 |
| Ethylene glycol | | | 9.0 | | | |
| Diethylene glycol | | | 9.0 | | | |
| 2-Pyrrolidone | | | | 7.0 | | |
| Trimethylolpropane | | | | | | |
| Xylitol | 1.0 | 1.0 | | | 1.0 | 1.0 |
| Surfynol E1010 *1 | | 1.0 | | | 0.5 | 0.5 |
| Acetylenol E100 *2 | | | 1.0 | 0.8 | | |
| Water | 80.0 | 79.0 | 77.0 | 78.2 | 79.5 | 79.5 |
| Dye concentration | 4.0 | 4.0 | 4.0 | 4.0 | 4.0 | 4.0 |
| Ratio of azo compound/anthrapyridone | 4.0 | 4.0 | 1.0 | 1.0 | — | 4.0 |
| compound | | | | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

TABLE 2-2
(units of the components shown in Table: % by mass)

| | | Comparative Example | | |
|---|---|---|---|---|
| Name of Component | | 7 | 8 | 9 |
| Azo compound | Exemplary Compound 1 | 3.2 | 3.2 | |
| General | Exemplary Compound 2 | | | |
| Formula (I) | Exemplary Compound 3 | | | |
| | Exemplary Compound 4 | | | |
| Anthrapyridone | Exemplary Compound 5 | | | |
| compound | Exemplary Compound 6 | | | |
| General | Exemplary Compound 7 | | | |
| Formula (II) | Exemplary Compound 8 | | | |
| | Comparative Compound 1 | | | |
| | Comparative Compound 2 | 0.8 | | |

| | | | |
|---|---|---|---|
| C.I. Direct Red 52 | | 0.8 | 4.0 |
| Glycerin | 2.0 | 2.0 | 2.0 |
| 1,5-Pentanediol | 10.0 | 10.0 | 10.0 |
| 1,2-Pentanediol | 3.0 | 3.0 | 3.0 |
| Ethylene glycol | | | |
| Diethylene glycol | | | |
| 2-Pyrrolidone | | | |
| Trimethylolpropane | | | |
| Xylitol | 1.0 | 1.0 | 1.0 |
| Surfynol E1010 *1 | 0.5 | 0.5 | 0.5 |
| Acetylenol E100 *2 | | | |
| Water | 79.5 | 79.5 | 79.5 |
| Dye concentration | 4.0 | 4.0 | 4.0 |
| Ratio of azo compound/anthrapyridone | 4.0 | — | — |
| compound | | | |

*1 Acetylene glycol-based surfactant manufactured by Nissin Chemical Industry Co., Ltd.
*2 Acetylene glycol-based surfactant manufactured by Kawaken Fine Chemicals Co., Ltd.

<Method for Evaluation of Ink Composition>

Each of the ink compositions obtained above was mounted on a thermal ink jet printer (LPR-E5000) manufactured by Sony Corporation having a line head. Further, an image was recorded on ink jet glossy paper (IJ-RC-UF170) manufactured by Mitsubishi Paper Mills Limited as a recording medium with a recording duty varying from 0% to 100% at an interval of 10%, and the obtained image was dried naturally at a temperature of 24° C. and a relative humidity of 60% for 24 hours.

The recorded matter thus obtained was used and measured for a* and b* in the L*a*b* color system defined by CIE (International Commission on Illumination) and an optical density, using a spectrophotometer (Spectorolino; manufactured by Gretag Macbeth) under the conditions of a light source of D50 and a field of view of 2°.

[Color Tone of Printed Matter]

The color angles (H°) were each calculated from the obtained values of a* and b*, and the color tones (color angles) were evaluated.

In a*≧0, b*≧0 (the first quadrant), H°=tan⁻¹ (b*/a*)

In a*≦0, b*≧0 (the second quadrant), H°=180+tan⁻¹ (b*/a*)

In a*≦0, b*≦0 (the third quadrant), H°=180+tan⁻¹ (b*/a*)

In a*≧0, b*≦0 (the fourth quadrant), H°=360+tan⁻¹ (b*/a*) Formula (A)

The evaluation criteria for color tones (color angles) are as follows. Further, the evaluation results are shown in Table 3. Further, in the present Example, for the following evaluation criteria, A indicates an ink composition having a particularly preferable magenta color tone, B indicates an ink composition having a preferable magenta color tone, and C indicates an ink composition having an unacceptable color tone as a magenta color tone.

A: H° of 0° or more and 5° or less

B: H° of more than 5° and 50° or less, or 350° or more and less than 360°

C: H° of more than 50° and less than 350°

[Light Resistance of Printed Matter]

Under the above-described conditions, an initial optical density (OD) was measured, and then the recorded matter was exposed for 180 hours using a Super Xenon Weather Meter XL-75 (manufactured by Suga Test Instruments Co., Ltd.) under the conditions of an irradiation intensity of 60 kilolux, an in-bath temperature of 22° C., and a relative humidity of 60%. Then, the optical density (OD) after the exposure test was measured using a spectrophotometer (Spectrolino; manufactured by Gretag Macbeth) under the conditions of a light source of D50 and a field of view of 2°. From these measurement results, the remaining optical density (ROD [%]) was measured by the following equation and the light resistance was evaluated in accordance with the following scoring criteria. Further, in the present Example, according to the following evaluation criteria, A indicates an ink composition having particularly preferable light resistance, B indicates an ink composition having preferable light resistance, and C indicates an ink composition having unacceptable light resistance.

ROD (%)=(OD after exposure test/initial OD)×100

A: ROD of 80% or more

B: ROD of 70% or more and less than 80%

C: ROD of less than 70%

[Ozone Resistance of Printed Matter]

The initial optical densities (OD) were measured under the above-described conditions, and the recorded matter was exposed for 72 hours under the conditions of 24° C., a relative humidity of 60% RH, and an ozone concentration of 5 ppm, using an Ozone Weather Meter OMS-H manufactured by Suga Test Instruments Co., Ltd. Then, the optical density (OD) after the exposure test was measured using a spectrophotometer (Spectrolino; manufactured by Gretag-Macbeth AG) under the conditions of a light source of D50 and a field of view of 2°. From these measurement results, the remaining optical density (ROD [%]) was measured the following equation and the ozone resistance was evaluated in accordance with the following scoring criteria. Further, in the present Example, according to the following evaluation criteria, A indicates an ink composition having particularly preferable ozone resistance, B indicates an ink composition having preferable ozone resistance, and C indicates an ink composition having unacceptable ozone resistance.

ROD (%)=(OD after exposure test/initial OD)×100

A: ROD of 80% or more

B: ROD of 70% or more and less than 80%

C: ROD of less than 70%

[Intermittent Discharging Stability]

Each of the ink compositions described in Tables 1-1 to 1-3 and Table 2 was mounted on a thermal ink jet printer (LPR-E5000) manufactured by Sony Corporation having a line head. The recording density was set to 600 dpi×600 dpi, and the ink was discharged from a predetermined nozzle under an environment of a temperature of 10° C. and a humidity of 15% RH. Then, the above-described predetermined nozzle was not used for a certain period of time, the ink was discharged from the above-described predetermined nozzle again, and recording was performed on ink jet glossy paper (IJ-RC-UF170) manufactured by Mitsubishi Paper Mills Limited as a recording medium. The image thus obtained was observed with the naked eye and evaluated for the intermittent discharging stability. The evaluation criteria for the intermittent discharging stability were as follows. Further, the evaluation results are shown in Table 3. Further, in the present Example, according to the following evaluation criteria, A indicates an ink composition having particularly preferable intermittent discharging stability, B indicates an ink composition having preferable intermittent discharging stability, and C indicates an ink composition having unacceptable intermittent discharging stability.

A: Recording was normally performed even after the nozzle was not used for 10 seconds.

B: Recording was normally performed even after the nozzle was not used for 5 seconds.

C: Non-discharging or blur of recording was observed after the nozzle was not used for 5 seconds.

[Color Bleeding Property]

Each of the ink compositions described in Tables 1-1 to 1-3 and Table 2 was mounted on a thermal ink jet printer (LPR-E5000) manufactured by Sony Corporation having a line head. Yellow, cyan, and black monochromic patterns close to magenta were printed on ink jet glossy paper (IJ-RC-UF170) manufactured by Mitsubishi Paper Mills Limited as a recording medium with a recording duty varying from 0% to 100% at an interval of 10%, with a recording density of 600 dpi×600 dpi and a discharge amount of 3.5 pL. Then, the image was dried naturally at a temperature of 24° C. and a relative humidity of 60% for 24 hours, and evaluated for the color bleeding property. The evaluation criteria for the color bleeding property were as follows. Further, the evaluation results are shown in Table 3. Further, in the present Example, according to the following evaluation criteria, A indicates an ink composition having a particularly preferable color bleeding property, B indicates an ink composition having a preferable color bleeding property, and C indicates an ink composition having an unacceptable color bleeding property.

A: Even with a recording duty of 80% or more, there is no color mixing and the boundary is clear.

B: Even with a recording duty of 60% or more, there is no color mixing and the boundary is clear.

C: Even with a recording duty of less than 60%, color mixing occurs.

TABLE 3

| | Color | Light | Ozone | | |
|---|---|---|---|---|---|
| | tone of | resistance | resistance | Intermittent | Color |
| | printed | of printed | of printed | discharging | bleeding |
| | matter | matter | matter | stability | property |
| Example 1 | A | A | A | A | B |
| Example 2 | A | A | A | A | B |
| Example 3 | A | A | A | A | A |
| Example 4 | A | A | A | B | A |
| Example 5 | A | A | A | A | A |
| Example 6 | A | A | A | A | B |
| Example 7 | A | A | A | A | B |
| Example 8 | A | A | A | A | A |
| Example 9 | B | A | A | A | A |
| Example 10 | B | A | A | A | B |
| Example 11 | A | A | A | A | A |
| Example 12 | A | A | A | B | A |
| Example 13 | A | A | A | A | A |
| Example 14 | A | A | A | A | A |
| Example 15 | A | A | A | A | A |
| Example 16 | A | A | A | A | A |
| Example 17 | A | A | A | A | A |
| Example 18 | A | A | A | A | A |
| Comparative | A | A | A | A | C |
| Example 1 | | | | | |
| Comparative | A | A | A | C | A |
| Example 2 | | | | | |
| Comparative | A | A | A | C | A |
| Example 3 | | | | | |
| Comparative | A | A | A | C | A |
| Example 4 | | | | | |
| Comparative | B | B | A | B | C |
| Example 5 | | | | | |
| Comparative | B | A | A | B | C |
| Example 6 | | | | | |
| Comparative | B | A | A | B | C |
| Example 7 | | | | | |
| Comparative | B | B | B | B | C |
| Example 8 | | | | | |
| Comparative | C | C | C | B | A |
| Example 9 | | | | | |

As shown in Table 3, it was evaluated that the ink compositions of Examples 1 to 18 were preferable or particularly preferable in terms of any of the color tone of the printed matter, the light resistance of the printed matter, the ozone resistance of the printed matter, the intermittent discharging stability of the printed matter, and the color bleeding property.

Furthermore, in Examples 1 to 4, the conditions were the same as each other except that only the contents of the acetylene glycol-based surfactant were changed. As shown in these Examples, it can be seen that it is preferable that the content of the acetylene glycol-based surfactant be about 0.5% by mass in order to attain compatibility between the color bleeding property and the intermittent discharging property at a high level.

Moreover, in Example 12 in which the total amount of the color materials was more than 5.00% by mass, the intermittent discharging stability was evaluated as “B”. Further, in Examples 9 and 10 in which the ratios of the azo compound/the anthrapyridone compound were out of the range of the present disclosure, the color tone was evaluated as “B”.

In addition, in Comparative Example 1 in which a surfactant was not included, the color bleeding property was deteriorated. Further, in Comparative Examples 2 to 4, the content of the acetylene surfactant was 0.8% by mass or more, the intermittent discharging stability was deteriorated. Further, in Comparative Examples 5 to 8 in which the azo compound of the general formula (I) was included and the anthrapyridone compound of the general formula (II) was not included, a result that the color bleeding property was deteriorated was obtained. In addition, in Comparative Example 9 in which the bisazo dye of the general formula (I) having excellent fastness was not included, a result that the fastness of an image (the light resistance of the printed matter and the ozone resistance of the printed matter) or the color tone of the printed matter was deteriorated was obtained.

As described above, the suitable embodiments of the present disclosure were described in detail with reference to the accompanying drawings, but the present disclosure is not limited to the referenced examples. It is apparent for an ordinary skilled person in the art that various modifications or variations can be added without departing from the technical spirit described in the Claims, and it is understood that such modifications or variations are encompassed by the technical scope of the present disclosure.

For example, the embodiments above were described with reference to the constitution of the ink jet recording apparatus and by way of an example of the line type ink jet recording apparatus, but the present disclosure is not limited to these examples. For example, the ink jet recording apparatus according to an embodiment of the present disclosure may be a serial type of an ink jet recording apparatus, in which a recording head reciprocally moves in the direction perpendicular to the transport direction of a recording medium.

The present disclosure contains subject matter related to that disclosed in Japanese Priority Patent Application JP 2010-189254 filed in the Japan Patent Office on Aug. 26, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An ink jet ink composition comprising at least:
a first color material which is an azo compound represented by the following general formula (I),
a second color material which is an anthrapyridone compound represented by the following general formula (II), and
a surfactant which is a compound having a structure represented by the following general formula (III), in which the surfactant is contained in an amount of 0.10% by mass or more and less than 0.80% by mass: 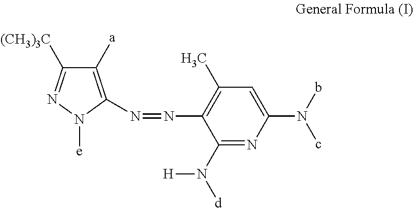
(in the general formula (I), a is an electron withdrawing group having a Hammett's σp value of 0.20 or more and less than 1.00. Further, b and d are each independently a phenyl group having one sulfo group, and a hydrogen atom of the phenyl group is further substituted. In addition, c and e each independently include a benzothiazole ring group having one sulfo group, and a hydrogen atom of the benzothiazole ring group is further substituted). 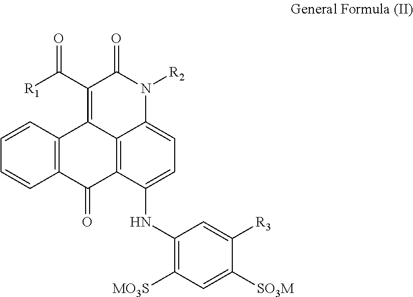
(in the general formula (II), R₁ is an alkoxy group having 1 to 6 carbon atoms or a 3-sulfophenyl group, and R₂ is a hydrogen atom or a methyl group. R₃ is a hydrogen atom or a methyl group, and a hydrogen atom of the methyl group is be further substituted, for which, however, a substituent bridged with an imino bridge (—NH—) is not chosen. Further, each M is independently a hydrogen atom, an alkali metal, ammonium, or organic ammonium). 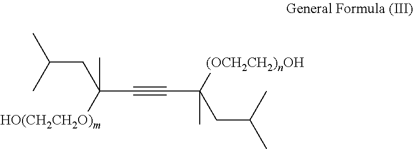
(in the general formula (III), m and n are an integer of 1 or more).

2. The ink jet ink composition according to claim 1, wherein the first color material is a compound represented by the following general formula (IV): 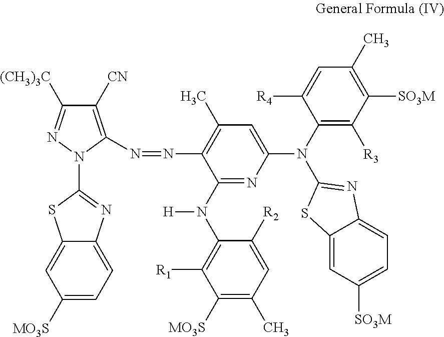
(in the general formula (IV), R₁, R₂, R₃, and R₄ are each independently an alkyl group, and a hydrogen atom of the alkyl group is further substituted. Further, each M is independently a hydrogen atom, an alkali metal, ammonium, or organic ammonium).

3. The ink jet ink composition according to claim 2, wherein the second color material is a compound represented by the following general formula (V): 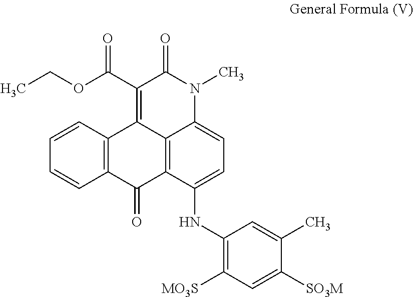
(in the general formula (V), each M is independently a hydrogen atom, an alkali metal, ammonium, or organic ammonium).

4. The ink jet ink composition according to claim 3, wherein the total content of the first color material and the second color material in the ink composition is 1.00% by mass or more and 5.00% by mass or less.

5. The ink jet ink composition according to claim 4, wherein the content (% by mass) of the first color material in the ink composition is 0.50 times or more and 4.00 times or less the content (% by mass) of the second color material in the ink composition in terms of a mass ratio.

6. The ink jet ink composition according to claim 1, wherein the surfactant has an HLB (Hydrophile-Lipophile Balance) value of 10 or more.

7. An ink jet recording method comprising:
discharging liquid droplets of an ink jet ink composition by an ink jet system to perform recording, wherein the ink composition includes at least a first color material which is an azo compound represented by the general formula (I), a second color material which is an anthrapyridone compound represented by the general formula (II), and a surfactant which is a compound having a structure represented by the general formula (III), in which the surfactant is contained in an amount of 0.10% by mass or more and less than 0.80% by mass: 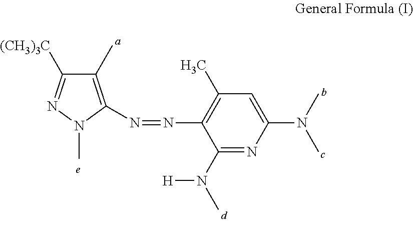
(in the general formula (I), a is an electron withdrawing group having a Hammett's σp value of 0.20 or more and less than 1.00. Further, b and d are each independently a phenyl group having one sulfo group, and a hydrogen atom of the phenyl group is further substituted. In addition, c and e each independently include a benzothiazole ring group having one sulfo group, and a hydrogen atom of the benzothiazole ring group is further substituted). 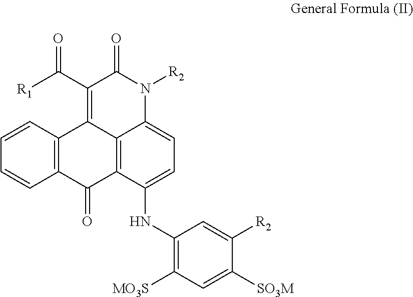
(in the general formula (II), R₁ is an alkoxy group having 1 to 6 carbon atoms or a 3-sulfophenyl group, and R₂ is a hydrogen atom or a methyl group. R₃ is a hydrogen atom or a methyl group, and a hydrogen atom of the methyl group is further substituted, for which, however, a substituent bridged with an imino bridge (—NH—) is not chosen. Further, each M is independently a hydrogen atom, an alkali metal, ammonium, or organic ammonium). 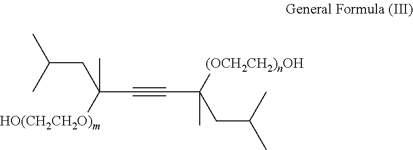
(in the general formula (III), m and n are an integer of 1 or more).

8. An ink cartridge comprising an ink-storing unit for storing an ink jet ink composition including at least a first color material which is an azo compound represented by the general formula (I), a second color material which is an anthrapyridone compound represented by the general formula (II), and a surfactant which is a compound having a structure represented by the general formula (III), in which the surfactant is contained in an amount of 0.10% by mass or more and less than 0.80% by mass: 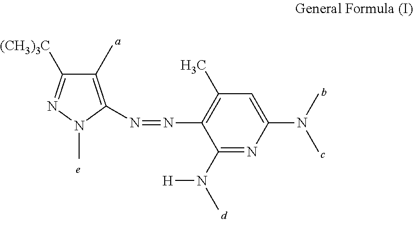
(in the general formula (I), a is an electron withdrawing group having a Hammett's σp value of 0.20 or more and less than 1.00. Further, b and d are each independently a phenyl group having one sulfo group, and a hydrogen atom of the phenyl group is further substituted. In addition, c and e each independently include a benzothiazole ring group having one sulfo group, and a hydrogen atom of the benzothiazole ring group is further substituted). 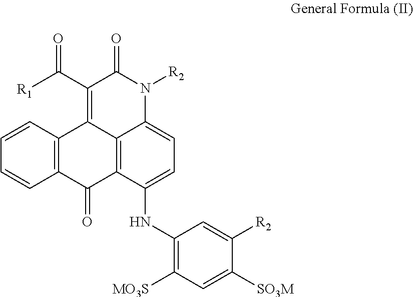
(in the general formula (II), R₁ is an alkoxy group having 1 to 6 carbon atoms or a 3-sulfophenyl group, and R₂ is a hydrogen atom or a methyl group. R₃ is a hydrogen atom or a methyl group, and a hydrogen atom of the methyl group is further substituted, for which, however, a substituent bridged with an imino bridge (—NH—) is not chosen. Further, each M is independently a hydrogen atom, an alkali metal, ammonium, or organic ammonium). 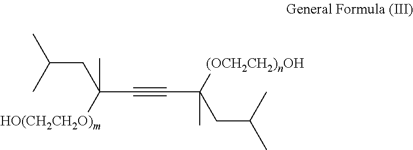
(in the general formula (III), m and n are an integer of 1 or more).

9. A recording unit comprising an ink cartridge having an ink-storing unit for storing an ink composition including at least a first color material which is an azo compound represented by the general formula (I), a second color material which is an anthrapyridone compound represented by the general formula (II), and a surfactant which is a compound having a structure represented by the general formula (III), in which the surfactant is contained in an amount of 0.10% by mass or more and less than 0.80% by mass, and a recording head for discharging liquid droplets of the ink composition stored in the ink-storing unit: 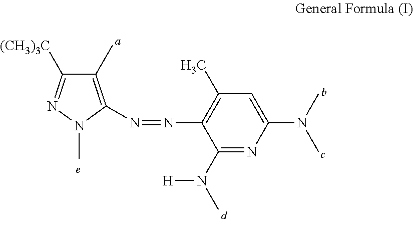
(in the general formula (I), a is an electron withdrawing group having a Hammett's σp value of 0.20 or more and less than 1.00. Further, b and d are each independently a phenyl group having one sulfo group, and a hydrogen atom of the phenyl group is further substituted. In addition, c and e each independently include a benzothiazole ring group having one sulfo group, and a hydrogen atom of the benzothiazole ring group is further substituted). 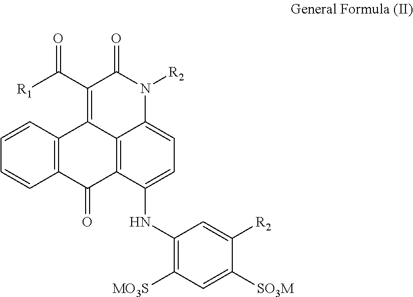
(in the general formula (II), R₁ is an alkoxy group having 1 to 6 carbon atoms or a 3-sulfophenyl group, and R₂ is a hydrogen atom or a methyl group. R₃ is a hydrogen atom or a methyl group, and a hydrogen atom of the methyl group is further substituted, for which, however, a substituent bridged with an imino bridge (—NH—) is not chosen. Further, each M is independently a hydrogen atom, an alkali metal, ammonium, or organic ammonium). 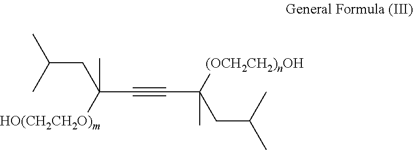
(in the general formula (III), m and n are an integer of 1 or more).

10. An ink jet recording apparatus including an ink cartridge having an ink-storing unit for storing an ink composition including at least a first color material which is an azo compound represented by the following general formula (I), a second color material which is an anthrapyridone compound represented by the following general formula (II), and a surfactant which is a compound having a structure represented by the following general formula (III), in which the surfactant is contained in an amount of 0.10% by mass or more and less than 0.80% by mass, and a recording head for discharging liquid droplets of the ink composition stored in the ink-storing unit: 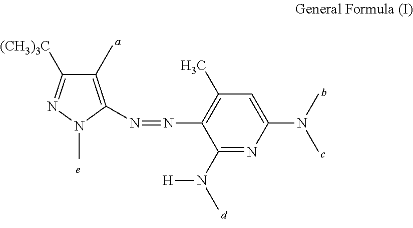
(in the general formula (I), a is an electron withdrawing group having a Hammett's σp value of 0.20 or more and less than 1.00. Further, b and d are each independently a phenyl group having one sulfo group, and a hydrogen atom of the phenyl group is further substituted. In addition, c and e each independently include a benzothiazole ring group having one sulfo group, and a hydrogen atom of the benzothiazole ring group is further substituted). 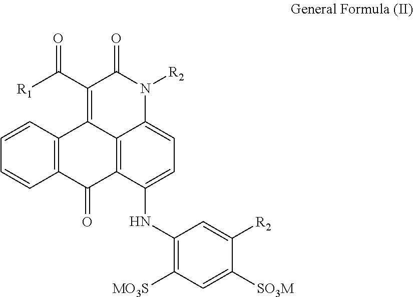
(in the general formula (II), R₁ is an alkoxy group having 1 to 6 carbon atoms or a 3-sulfophenyl group, and R₂ is a hydrogen atom or a methyl group. R₃ is a hydrogen atom or a methyl group, and a hydrogen atom of the methyl group is further substituted, for which, however, a substituent bridged with an imino bridge (—NH—) is not chosen. Further, each M is independently a hydrogen atom, an alkali metal, ammonium, or organic ammonium). 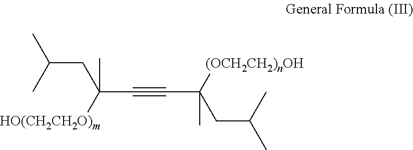
(in the general formula (III), m and n are an integer of 1 or more).
